(19) United States
(12) Patent Application Publication
(10) Pub. No.: US 2011/0134930 A1
(43) Pub. Date: Jun. 9, 2011

(54) PACKET-BASED NETWORKING SYSTEM

(76) Inventors: Moray McLaren, Bristol (GB); Alan Lynn Davis, Coalville, CA (US)

(21) Appl. No.: 12/634,224

(22) Filed: Dec. 9, 2009

(51) Int. Cl. H04L 12/56

(52) U.S. Cl. 370/401

(57) ABSTRACT

One embodiment of the present invention is directed to a networking system comprising a sending device, a receiving device, electronic communications components and transmission media through which the sending device and receiving device exchange data packets, and a networking protocol implemented in executable routines, firmware, hardware, or a combination of two or more of executable routines, firmware, hardware that provides for transmission of data in an ordered set of data packets through a sequence established between the sending device and receiving device as a result of transmitting a first data packet from the sending device to the receiving device and returning an acknowledgement by the receiving device to the sending device.

### TECHNICAL FIELD

The present invention is related to networking protocols and networking systems.

### BACKGROUND OF THE INVENTION

Electronic-data exchange through computer networks among computers, cell phones, and processing components of various computer systems and electronic devices underlies many fields of technology and commerce, including the Internet, complex distributed computer systems, financial-transaction systems, communications systems, and many other technical and commercial fields. Computer networking systems are complex, multi-tiered systems implemented in software, hardware circuitry, and electronic communications hardware and transmission media. A variety of hierarchically organized networking protocols, implemented in executable software routines, firmware, hardware, and various combinations of software, firmware, and hardware, provide a variety of data-exchange services and features while, at the same time, providing various levels of reliability and accuracy in data exchange between communicating devices and systems.

There are many different networking protocols and types of networking protocols. The transmission control protocol and Internet protocol (“TCP/IP”) is one of the most widely used networking protocols for computer systems, providing data-exchange services on which the Internet, various file-transfer services, and other types of communications services are implemented. TCP/IP, like many networking protocols, provides a connection-based communication between pairs of computers and/or other electronic devices. A first device initiates data transfer to a second device by requesting a connection and then, once a connection is established, transmitting data packets from the first computer to the second computer. In general, the connections remain open until one of the two computers initiates closing of the connection. Connections are associated with state information, which is electronically stored within each of the pair of computers during the lifetime of the connection. Establishing a connection and removing a connection involves significant time and communications overhead. While TCP/IP and other connection-based networking protocols provide adequate functionality and utility in many computational environments, there are other computational environments in which the computational overheads associated with TCP/IP and other similar networking protocols present a significant obstacle to practical implementation of network-communications-based technologies and systems. For that reason, designers, vendors, and users of networking protocols and networking-protocol-based facilities and services continue to seek improved communications methodologies that provide data exchange among computer systems under various types of constraints.

### BRIEF DESCRIPTION OF THE DRAWINGS

FIG. 1 illustrates a typical, example task carried out in a typical computer-networking environment.

FIGS. 2A-B illustrate a first step in carrying out the example data-file-transfer tasks described above with reference to FIG. 1.

FIGS. 3A-B illustrate the example transfer of the data file, discussed above with reference to FIG. 1, from the first computer to the second computer through the connection established between the first computer and the second computer, as discussed above with reference to FIGS. 2A-B.

FIG. 4 illustrates removal or deletion of a previously established connection.

FIG. 5 illustrates certain of the problems that may arise in multi-data-packet data exchanges, such as that discussed above with reference to FIG. 1-4.

FIG. 6 shows general layers within a networking system.

FIG. 7 shows an abstract representation of an example multi-node distributed computer system or other densely interconnected system containing discrete communicating devices or components.

FIGS. 8A-M illustrate a data-transfer operation, similar to that introduced in FIGS. 1-4, carried out according to a networking system that represents one embodiment of the present invention.

FIGS. 9A-D illustrate data structures employed by the networking system that represents one embodiment of the present invention.

FIGS. 10 and 11 provide state-transition diagrams that describe one embodiment of the networking system of the present invention.

FIGS. 12A-F provide control-flow diagrams for one server-side embodiment of the networking system of the present invention.

FIGS. 13A-C provide control-flow diagrams for one receiving-side embodiment of the networking system of the present invention.

### DETAILED DESCRIPTION OF THE INVENTION

The present invention is related to networking protocols and networking systems. One embodiment of the present invention is a networking system in which communicating devices establish sequences, analogous to connections in many common networking protocols, with greater efficiency and lower overhead than connections are established in connection-based networking protocols. While connection establishment generally involves three-message handshake connection-establishment protocols, prior to data transfer, sequences are established during sending and acknowledgement of an initial data packet, according to certain embodiments of the present invention. The memory overhead for sequences is less than that for connections, and less time and communications overhead are expended in establishing sequences than in establishing connections. Low connection overhead is particularly valuable in densely interconnected, distributed computer systems.

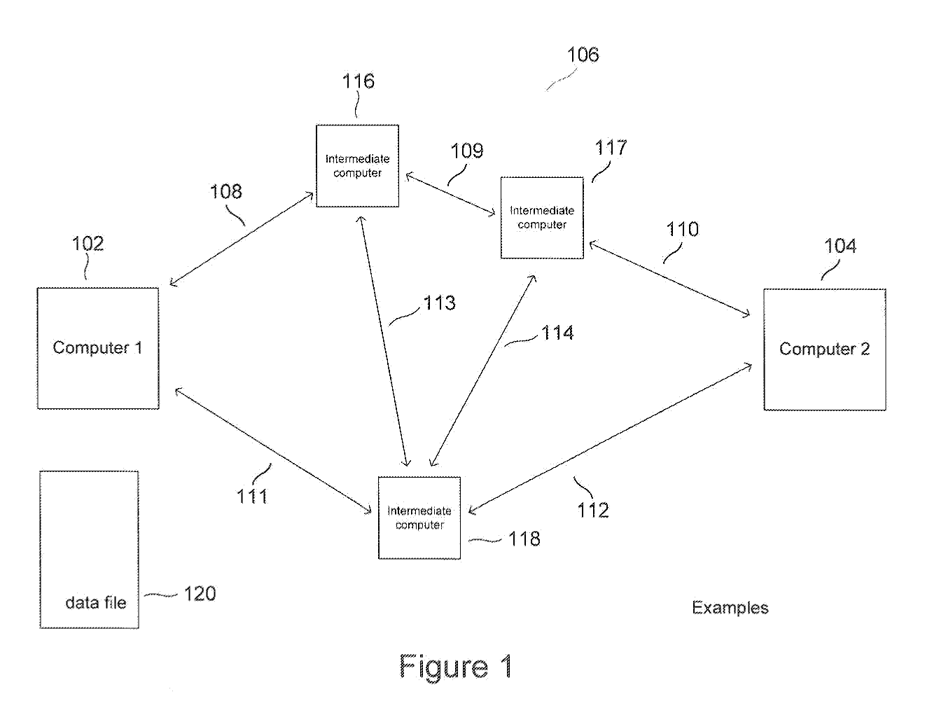

FIG. 1 illustrates a typical, example task carried out in a typical computer-networking environment. A first computer 102 is connected with a second computer 104 through a computer network 106 comprising data links 108-114 and intermediate computers or networking devices 116-118. A file 120 currently resides in memory and/or mass-storage devices of the first computer 102 and needs to be transferred from the first computer to the second computer 104.

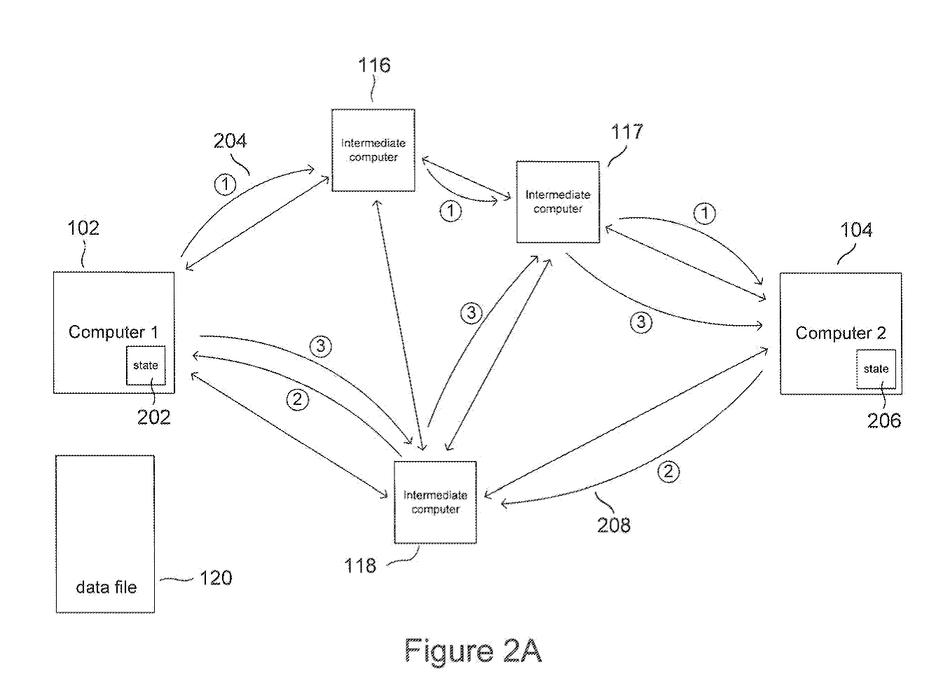

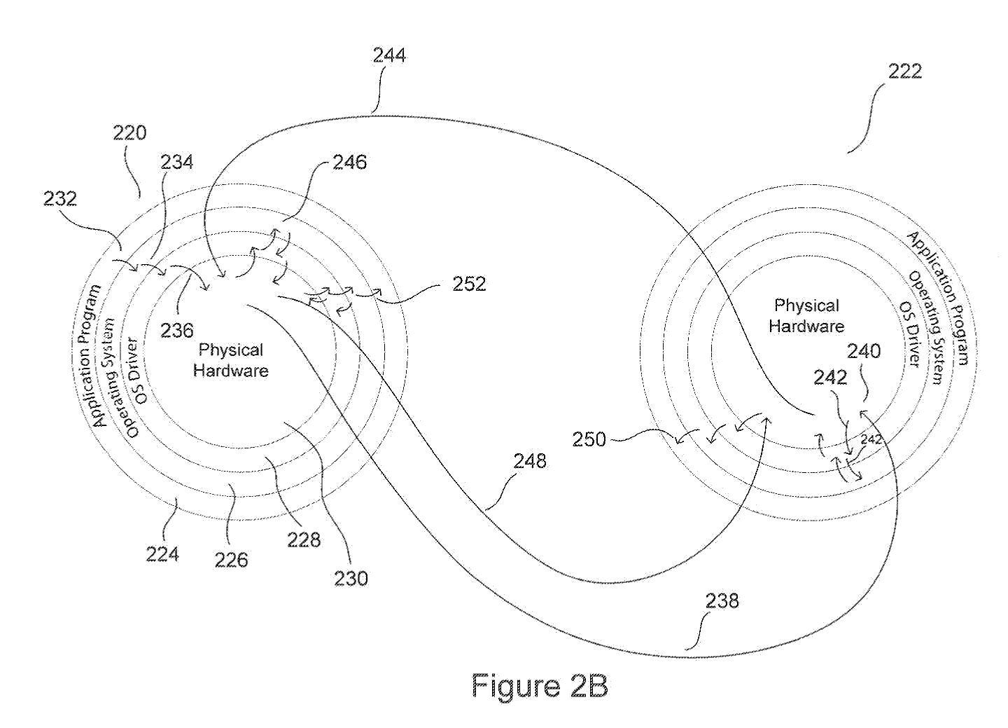

FIGS. 2A-B illustrate a first step in carrying out the example data-file-transfer tasks described above with reference to FIG. 1. In order to transfer the data file 120, the first computer 102 initiates establishment of a connection with the second computer 104. Connections are established by various different techniques in different networking protocols. In one technique, the first computer allocates and initializes state information 202 for the connection in memory and then carries out a three-message handshake operation with the second computer 104 to establish a connection between the first computer and the second computer. A connection request message is first sent. In the example shown in FIG. 2A, the connection-request message, transmission of which is represented by arrows associated with a circled “1,” such as arrow 204, traverses intermediate computers 116 and 117 in the course of being transmitted by the network to the second computer 104. The particular path taken by a message through the network may vary, depending on network-traffic conditions, the current networking load on the intermediate computers, failed connections on the intermediate computers, and other considerations. Upon receiving the connection request, the second computer also allocates and initializes state information 206 stored in the second computer's memory, and then returns a response-to-connection-request message, the path of which is shown in FIG. 2A by curved arrows associated with a circled “2,” such as arrow 208. The response-to-connection-request message traverses intermediate computer 118 in the example shown in FIG. 2A. Finally, upon receiving the response-to-connection-request message, the first computer transmits an acknowledgement (“ACK”) message to the second computer, the path of which is shown by curved arrows associated with the number “3,” such as curved arrow 210.

FIG. 2B illustrates the connection process, discussed above with reference to FIG. 2A, in terms of software and hardware layers of the first and second computers. The first computer is represented by a first set of concentric rings 220 and the second computer is represented by a second set of concentric rings 222. The sets of concentric rings used to depict the first and second computers in FIG. 2B include an outer, application-program ring 224, an operating-system ring 226, an OS-driver ring 228, and a physical-hardware inner disk 230. In general, the connection request is initiated from an application program 232 via a call to the operating system of the first computer. The operating system constructs a connection-request message and passes it to an operating-system driver 234. The operating-system driver interfaces to the physical hardware 236, including a network-device controller, which transmits the connection-request message through an electronic communications medium 238 to the second computer. The physical hardware generally includes one or more processors for executing the application program and operating system, one or more electronic memories, and, in certain cases, one or more mass-storage devices. In the second computer, the connection-request message is received by a physical network device 240 and the message is passed through an operating-system driver 242 to the operating system of the second computer. The operating system of the second computer responds by transmitting the response-to-connection-request message back through the OS driver and physical layer to the first computer 244. The response-to-connection-request message is passed back up to the operating system of the first computer 246, which prepares and sends an ACK message back to the second computer 248. The second computer passes the ACK message up through to the operating system, which, in general, generates a new-connection event to a listening application program 250. In addition to sending the ACK message, the operating system of the first computer returns a successful connection status 252 back to the application program on the first computer that initiated the connection request.

As can be seen from FIGS. 2A-B, the process of establishing a connection between two computers involves transmission of three different messages between the first and second computers, allocating and initializing stored state information on the first and second computer, and a delay in time needed for the messages to be constructed, passed through various software and hardware layers of the computers, and electronically transmitted between the two computers.

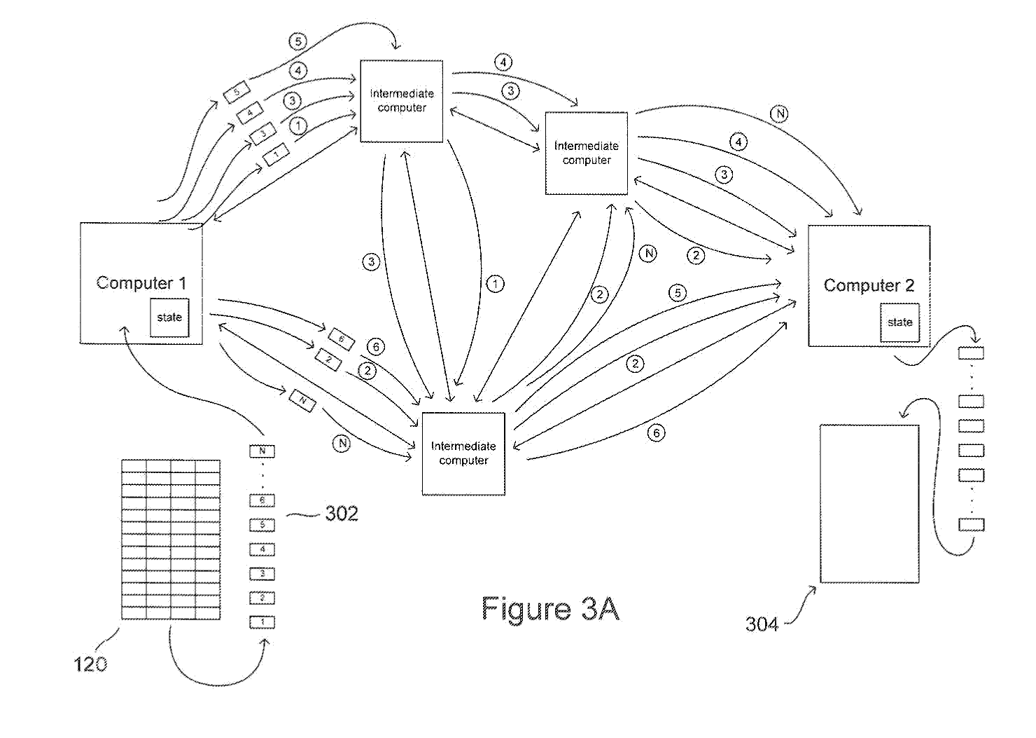

FIGS. 3A-B illustrate the example transfer of the data file, discussed above with reference to FIG. 1, from the first computer to the second computer through the connection established between the first computer and the second computer, as discussed above with reference to FIGS. 2A-B. FIGS. 3A-B use the same illustration conventions as used in FIGS. 2A-B. Once the connection is established, the data file 120 is logically divided into chunks of data 302 which are packaged into a sequence of data packets that are transmitted, one by one, from the first computer to the second computer. As shown in FIG. 3A, the data packets may be transmitted through different paths through the network to the second computer, again depending on network traffic conditions, network load on the intermediate computers, link failures and intermediate computer failures, and other considerations. As the packets are received by the second computer, they are transferred into memory, according to their position within the sequence of packets, to reconstitute the data file 304 in the memory of the second computer. In the current discussion, memory may constitute electronic random-access memory (“RAM”), data stored on any of various different types of internal mass-storage devices, data stored in various types of external data-storage devices, or data distributed among electronic memory, internal mass-storage devices, and external data-storage devices. In general, although not shown in FIG. 3A, each data packet transmitted from the first computer to the second computer is acknowledged by a separate ACK message sent from the second computer back to the first computer. FIG. 3B illustrates transmission of the data file with respect to the software and hardware layers within the first and second computers using the same illustration conventions as used in FIG. 2B. As in the case of the messages involved in establishing a connection, the data packets and ACK messages traverse the operating-system, operating-system-driver, and physical-hardware layers within each computer.

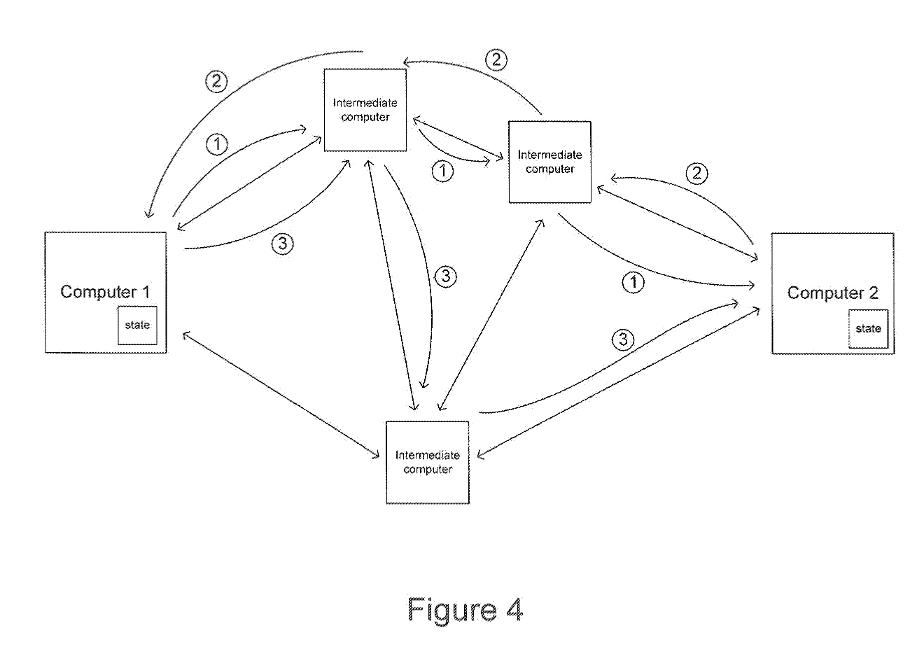

FIG. 4 illustrates removal or deletion of a previously established connection. As shown in FIG. 4, a connection deletion also generally involves a three-message or four-message handshake operation, upon successful completion of which the memory used to store the state information for the connection on both the first and second computers can be de-allocated.

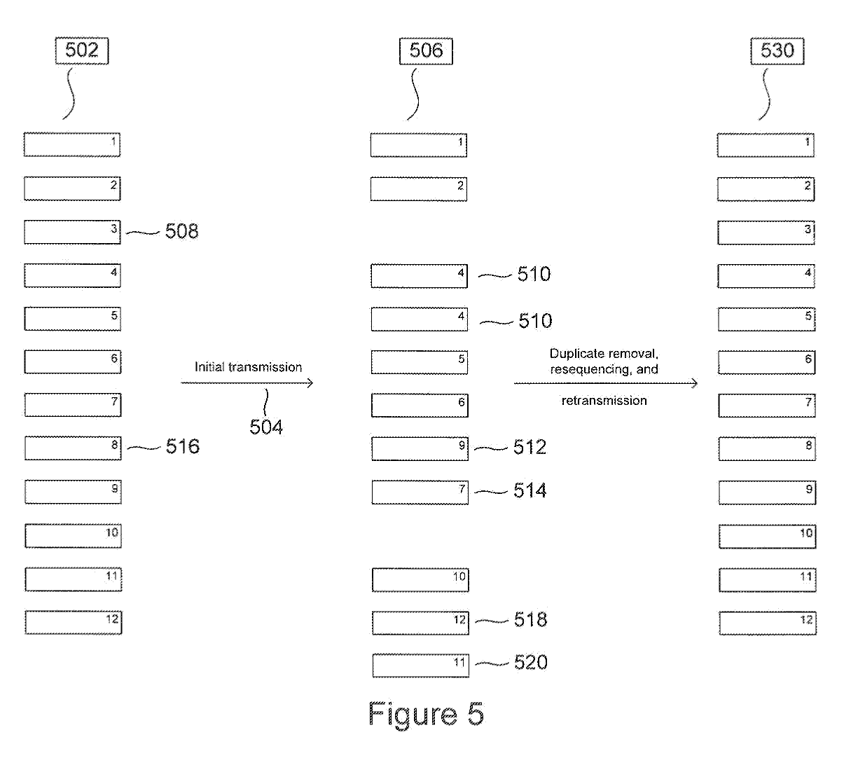

FIG. 5 illustrates certain of the problems that may arise in multi-data-packet data exchanges, such as that discussed above with reference to FIG. 1-4. In FIG. 5, a first, ordered sequence of data packets 502 is transmitted 504 from a first computer to a second computer. The second computer receives the data packets 506 shown in the middle column of FIG. 5. A number of problems have clearly arisen in the data exchange. First, data packet 3 508 was not received by the second computer. Second, the second computer received two identical copies of the fourth data packet 510. Third, the second computer received the ninth data packet 512 prior to receiving the seventh data packet 514. Fourth, the second computer failed to receive the eighth data packet 516. Fifth, and finally, the eleventh and twelfth data packets were received out of order 518 and 520 by the second computer. A data packet may fail to be received for any number of different reasons, including link, intermediate-computer, and other hardware, firmware, and software failures. A data packet may be duplicated when an ACK message returned from the second computer to the first computer to acknowledge receipt of the first-received copy of the data packet is lost, resulting in retransmission of the data packet by the first computer. The packets may be received out of order due to being sent on different paths through the network, as shown in FIGS. 2A and 2B, with the first-sent data packet transmitted on a pathway with a longer delay than the pathway to which the second packet is sent.

A networking protocol, such as TCP/IP, includes logic to detect and ameliorate these various different types of problems discussed above with reference to FIG. 5. The networking protocol may detect and remove duplicate packets, re-sequence received packets to restore their original order, and re-transmit lost packets, automatically, so that, despite the occurrence of various different types of problems, the second computer finally receives the ordered sequence of packets 530 originally transmitted by the first computer. Many problems can also occur at the physical-hardware levels of a computer network, and hardware layers also include many different error-detection and error-correction methodologies. As one example, the data may be corrupted by noise or systematic transmission errors, and the hardware uses cyclic redundancy check bits, included in addition to the data in messages transmitted through the network, to detect such data corruption and either correct the data corruption or initiate re-transmission of the corrupted message.

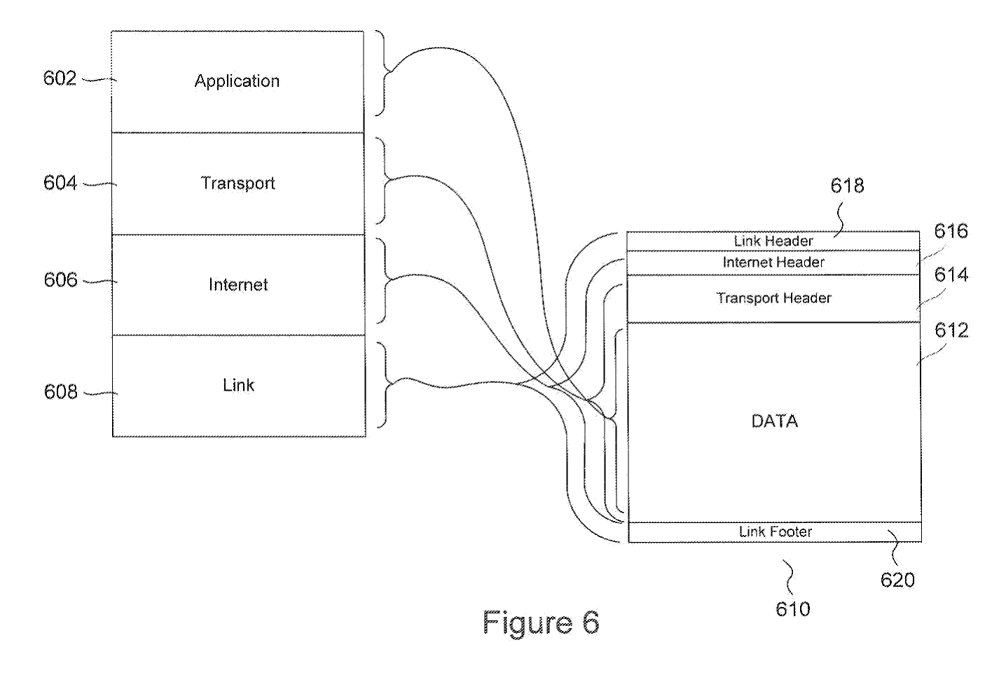

FIG. 6 shows general layers within a networking system. The layers include the application layer 602, which provides an interface between an application program or other initiator of data transfer and a networking subsystem or facility, a transport layer 604 which is responsible for packetizing and dc-packetizing data and correcting various types of errors discussed above with reference to FIG. 5, an Internet layer 606 which is responsible for routing messages through the computer network along various possible pathways, as shown in FIGS. 2A and 3A, and a link layer 608 which generally comprises the physical hardware, including network-device controllers, network devices, and physical communications media. Data packets sent through the electronic communications media according to the networking protocol are generally encapsulated in hierarchical layers corresponding to the network protocol layers 602, 604, 606, and 608. A data packet 610 generally comprises the data 612 furnished by the application layer to the networking protocol through an application-layer interface, a transport-layer header 614 which includes source and destination identifiers, a data-packet sequence number, and various additional flags and information used by the transport layer to detect and correct the types of errors discussed with reference to FIG. 5, an Internet-layer header 616, and a link-layer header 618 and footer 620. Each of the headers includes information used by the corresponding network protocol layer to direct the data packet to the corresponding layer on the receiving computer and to detect and correct various types of errors for which the layer is responsible.

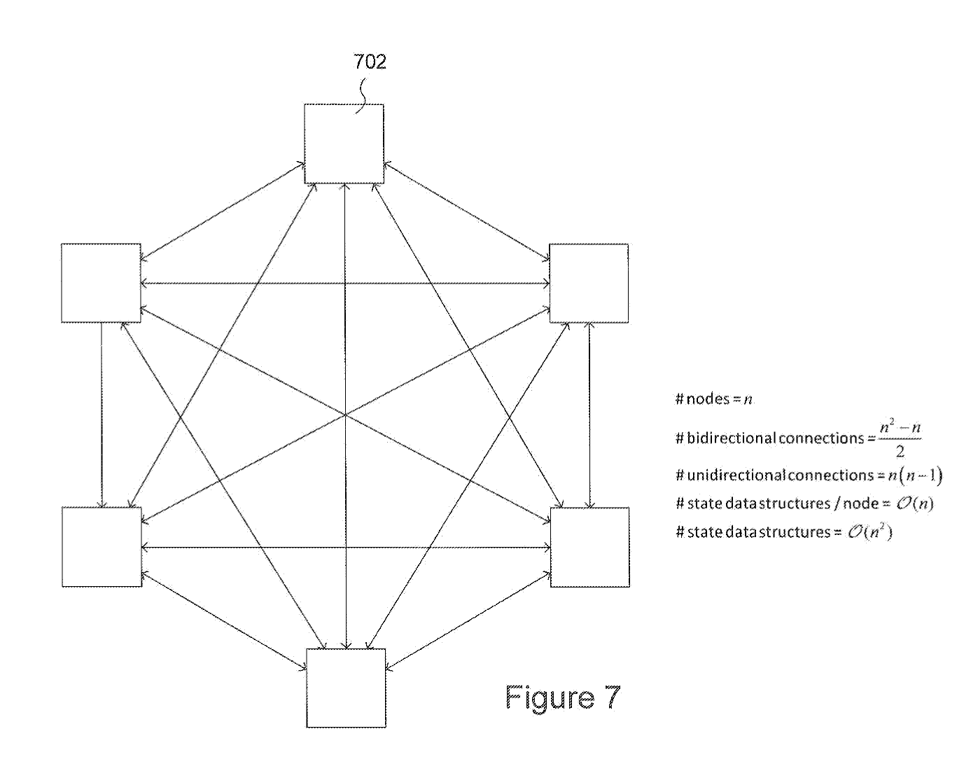

FIG. 7 shows an abstract representation of an example multi-node distributed computer system or other densely interconnected system containing discrete communicating devices or components. Each node in the figure, such as node 702, represents a component or device. In many distributed computational environments, each node may need to communicate with all remaining nodes at various points in time. When electronic communications and networking protocols are used to interconnect the nodes, the interconnection of all the nodes with another generally involves establishing pairwise connections between all possible pairs of nodes. When the networking protocol supports bi-directional connections, where a data transfer can be initiated by either of both nodes connected by a connection, full interconnection of the nodes requires

$$\frac{{n}^{2} - n}{2}$$

bi-directional connections. If only unidirectional connections are available, which support only one-way data transfer, full interconnection of the nodes involves at least n²−n unidirectional connections. The total number of connection-state data structures stored within the distributed system is therefore θ(n²) and the number of connection-state data structures stored on each node is θ(n). Distributed systems are quite large, featuring thousands, tens of thousands, or more nodes. Use of standard networking protocols, as discussed with reference to FIGS. 1-6, to interconnect all of the nodes within such systems involves maintenance of an enormous amount of connection-state information. Furthermore, the connections are relatively persistent, requiring a three-message handshake operation to establish the connection and a three-message or four-message connection-removal handshake operation to remove the connection. Overhead in time and processing cycles to establish and remove connections necessitates relatively persistent connections even under high-load scenarios, in which memory may be depleted or exhausted by the storage space required for connection-state information, because, otherwise, the overhead for each data exchange may grow to many times the overhead for the actual data-transfer operation that occurs following connection establishment and precedes connection removal. In other words, it makes little sense to expend the various overheads to establish and remove a connection in order to transfer only one or a few data packets. The relative persistence of connections may exacerbate resource exhaustion at high load, since many connections for which state information is stored may be idle, at any given point in time. For these reasons, an alternative approach to electronic-communications network protocols is may better facilitate efficient interconnection of nodes in large, distributed systems.

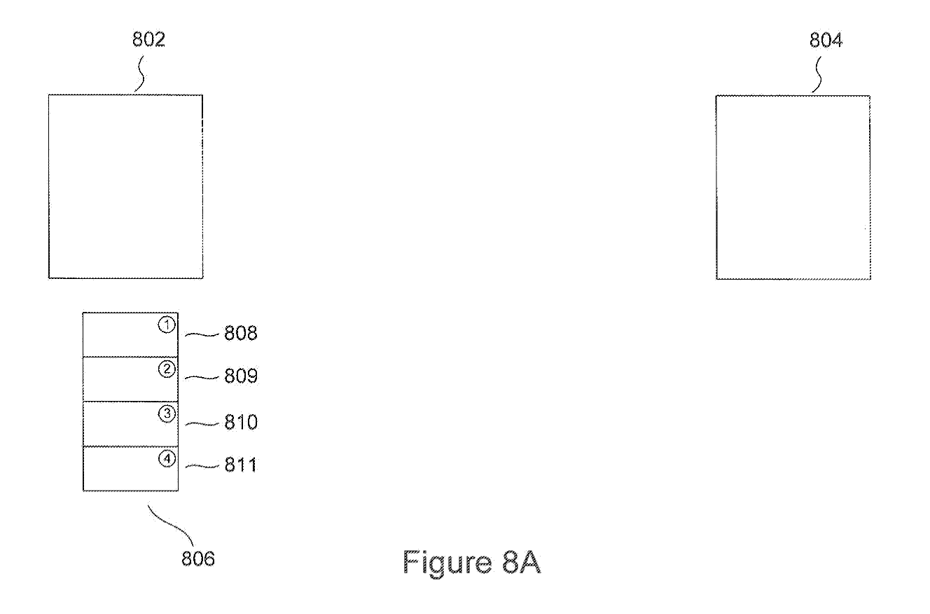

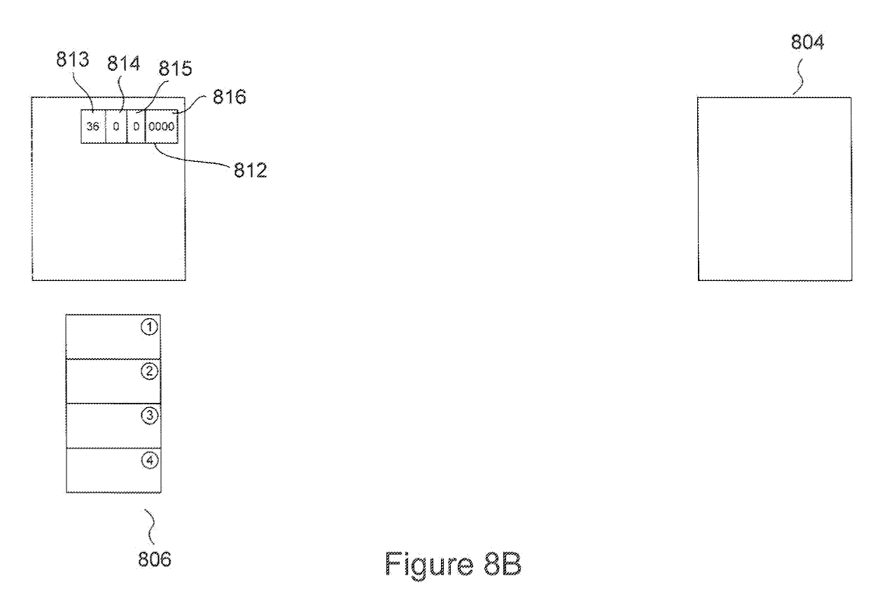

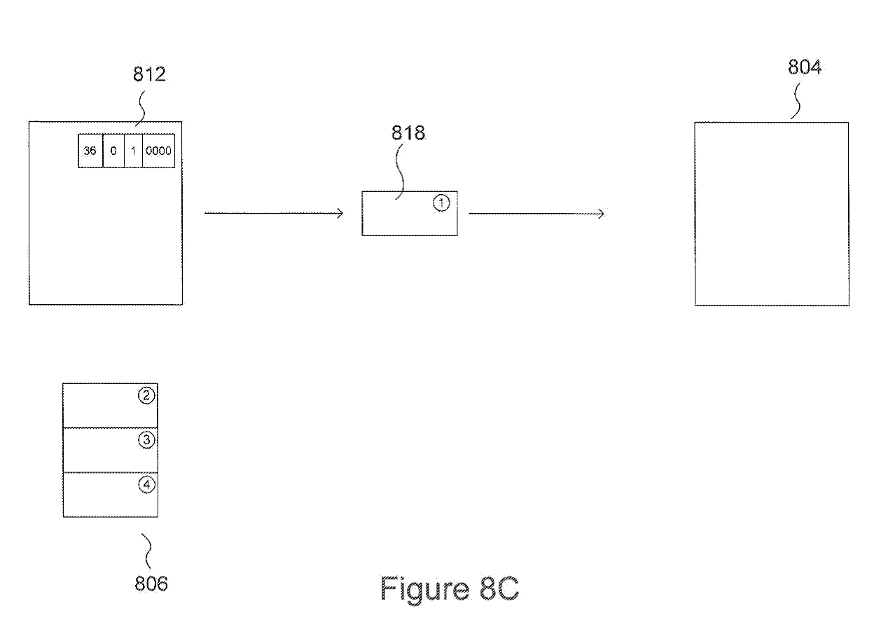

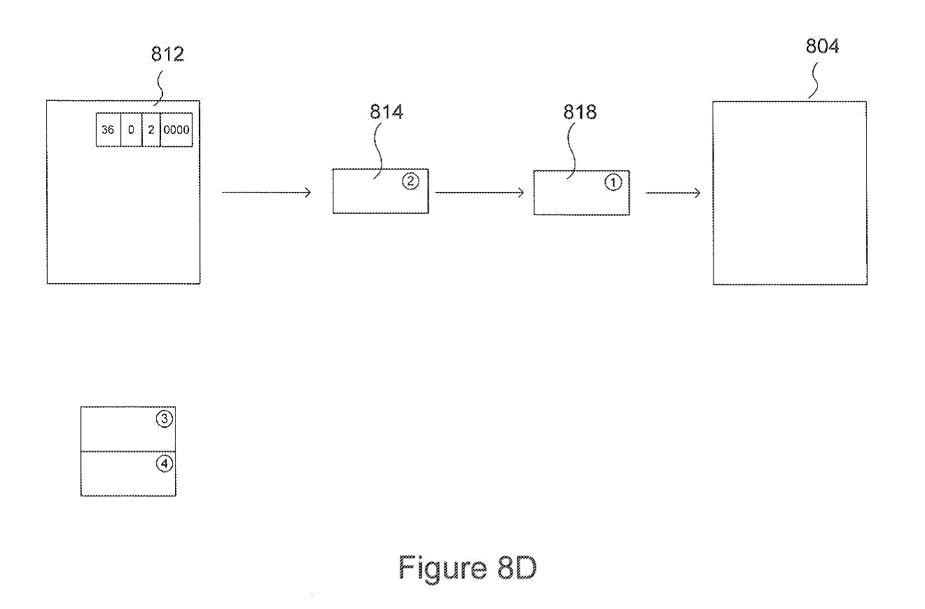

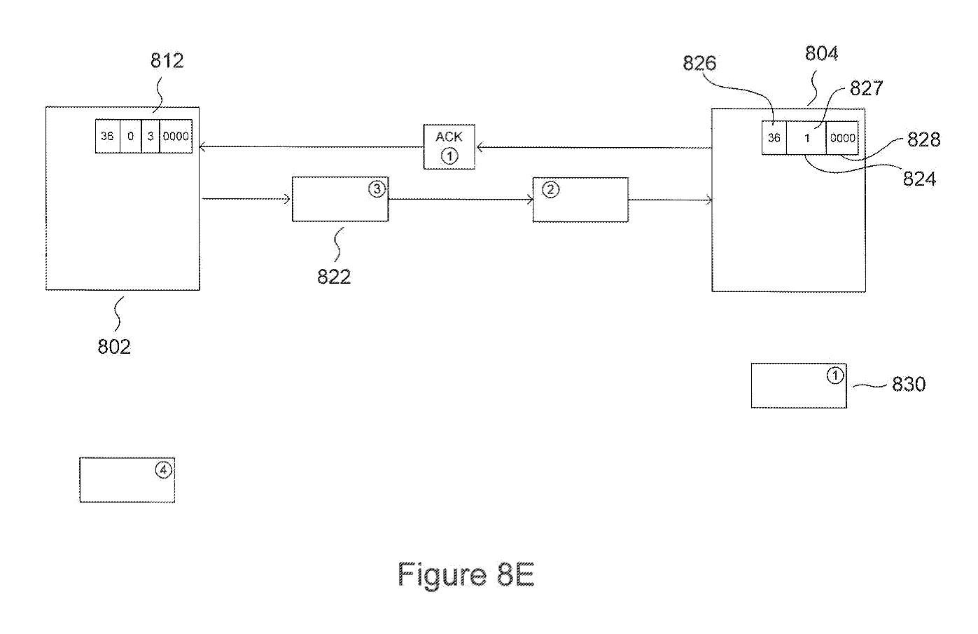

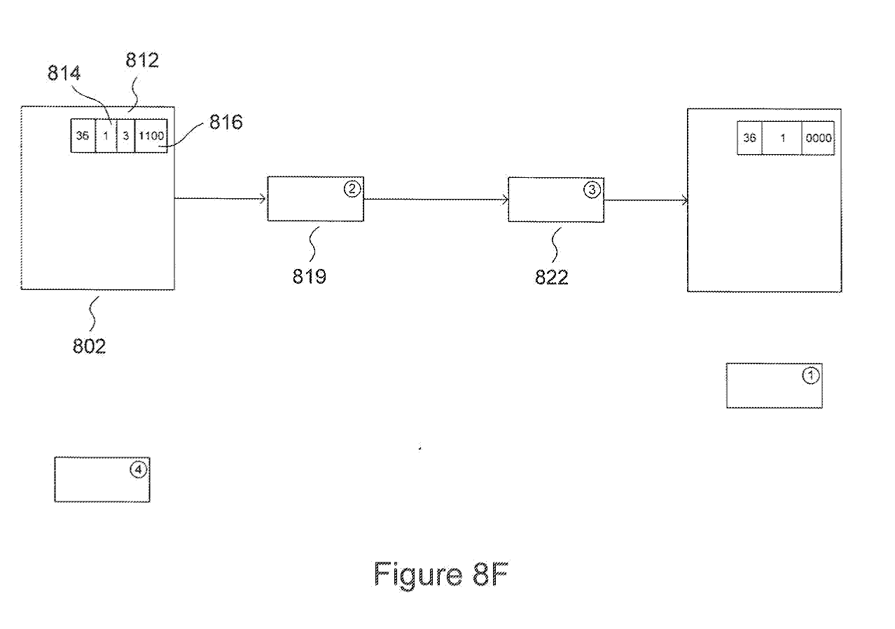

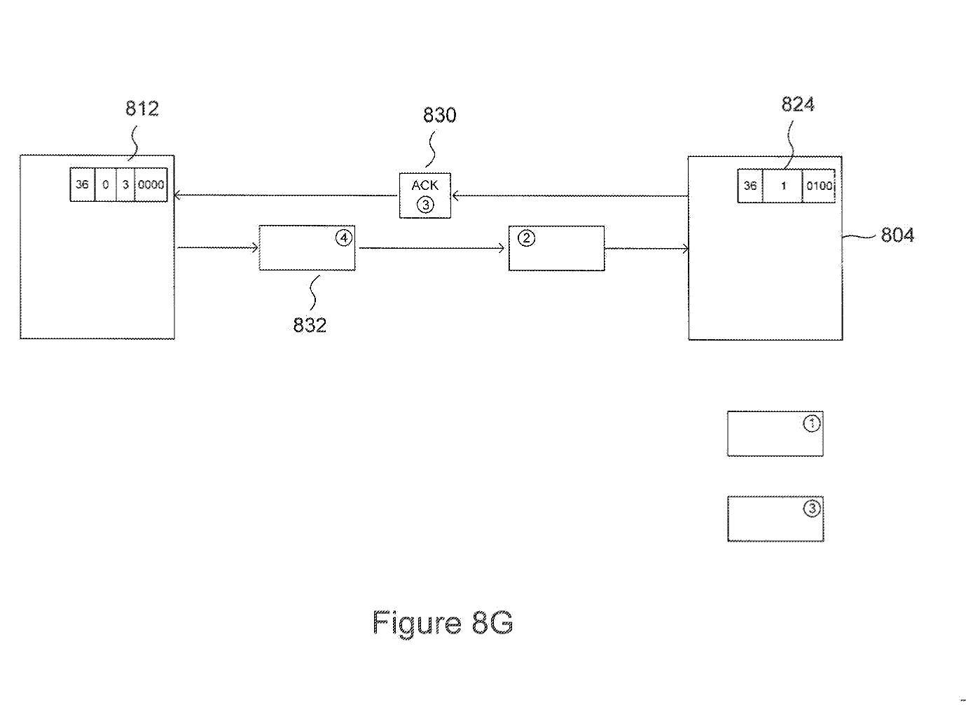

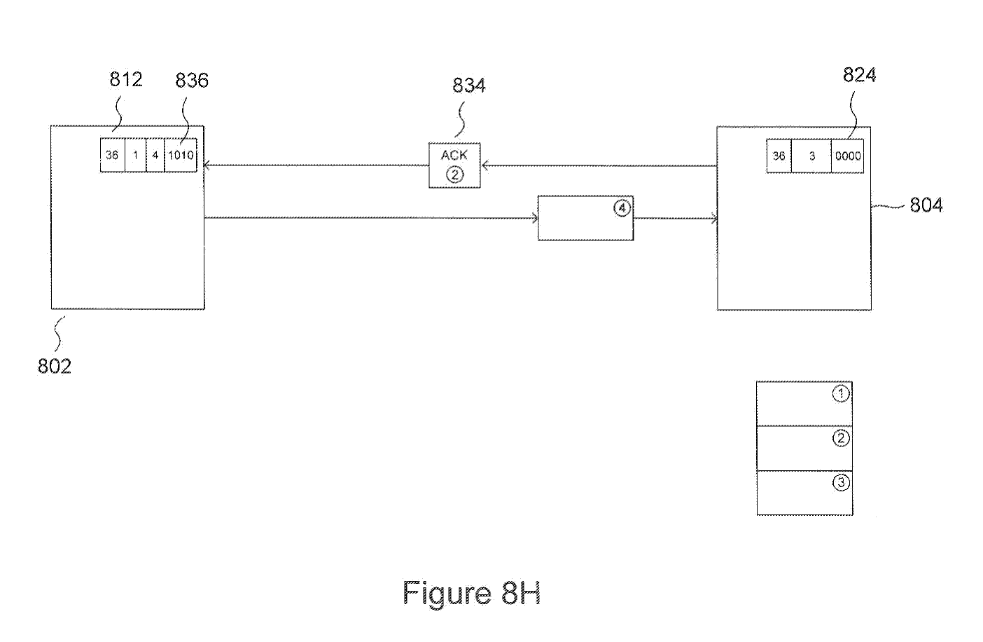

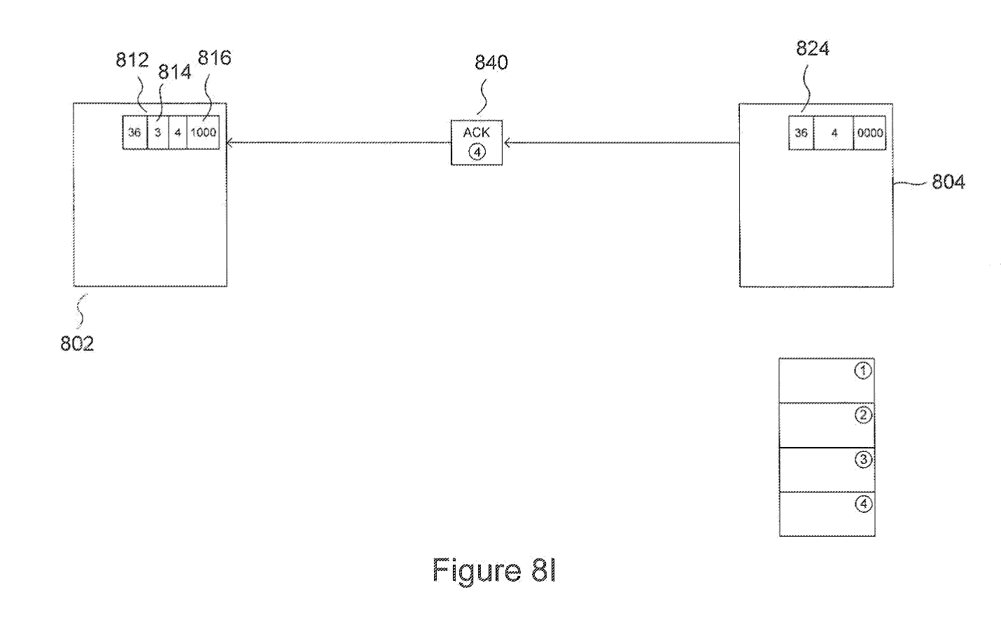

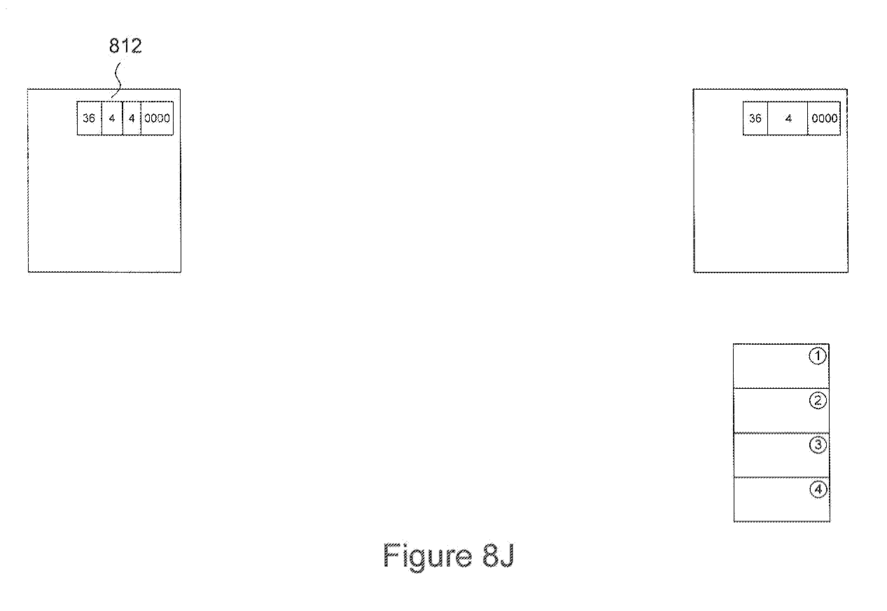

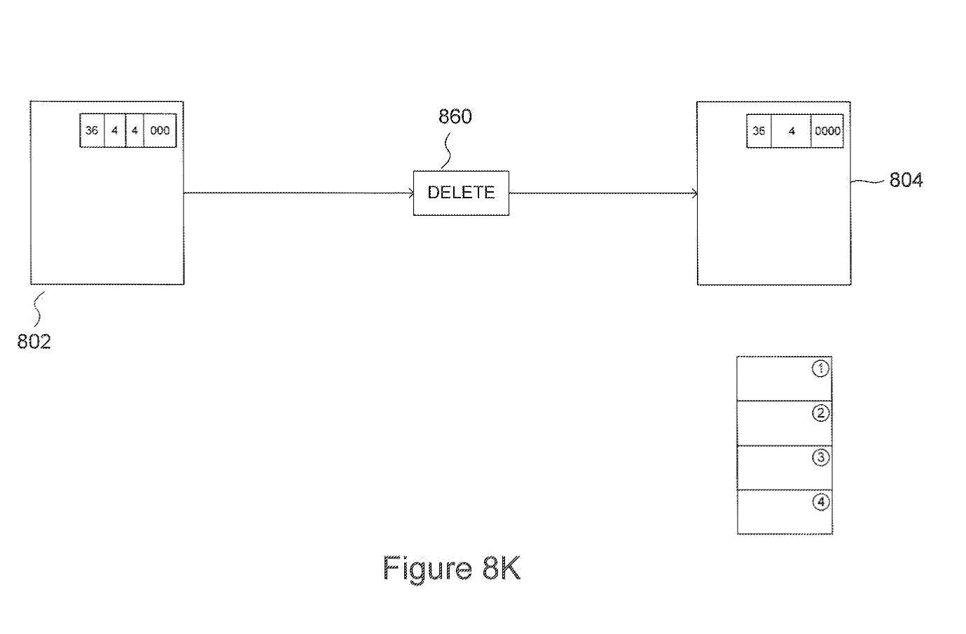

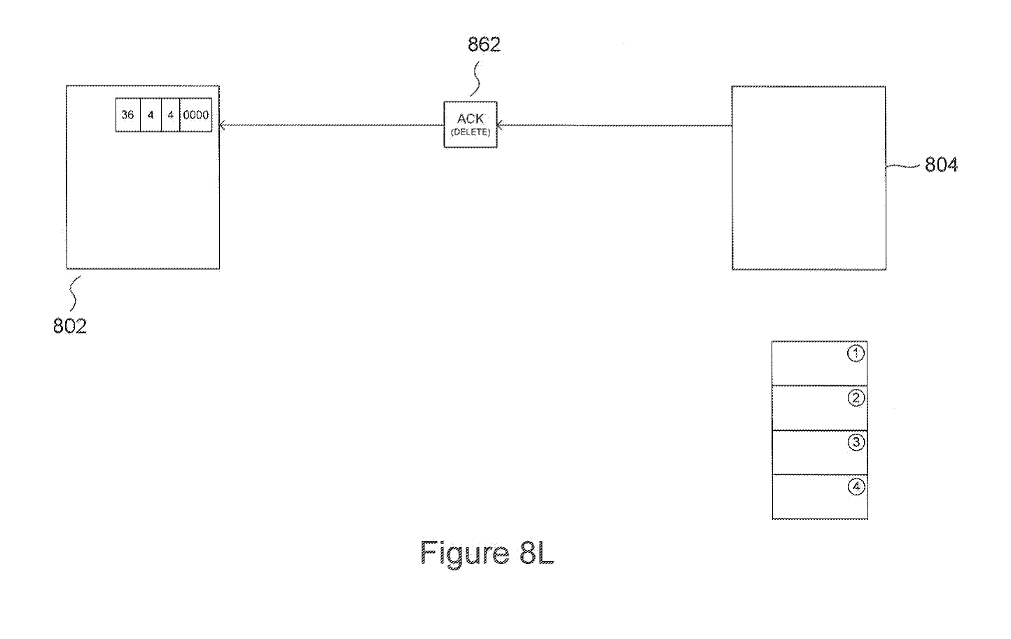

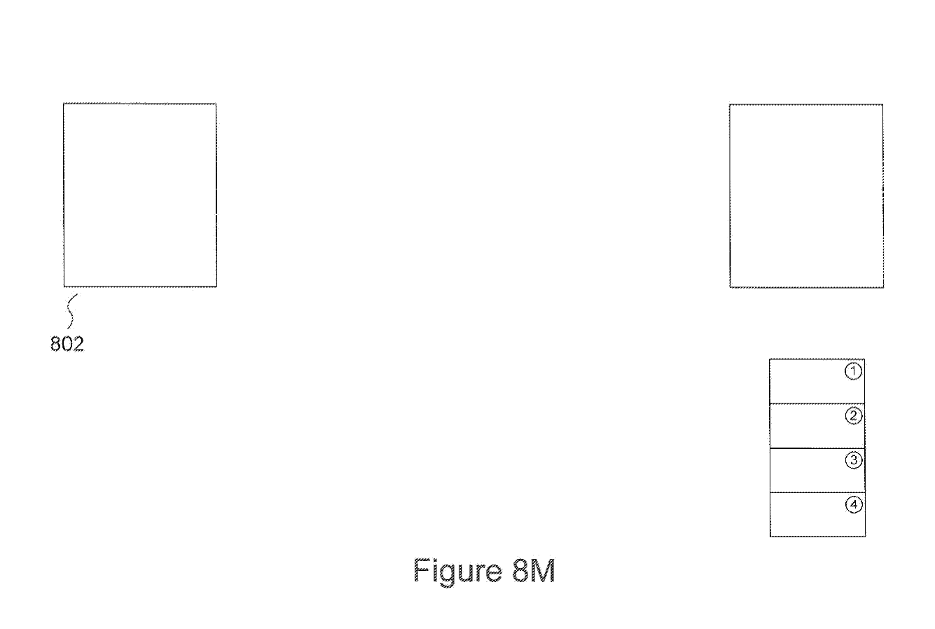

FIGS. 8A-M illustrate a data-transfer operation, similar to that introduced in FIGS. 1-4, carried out according to a networking system that represents one embodiment of the present invention. The data-transfer operation provides one example of operations that may be carried in networking-protocol embodiments of the present invention. In FIG. 8A, as in the remaining FIGS. 8B-8M, a first computer and a second computer are represented by rectangles 802 and 804, respectively. A data file 806 resides in memory of the first computer 802. The first computer needs to transmit the data file to the second computer 804. As shown in FIG. 8A, the data file has a length such that the data file can be divided into four different portions 808-811 for transmission through an electronic communications medium. A networking system may use a single maximum data packet size, or may be configurable to use various different maximally sized data packets. Data-packet sizes are generally chosen to optimize data-transmission efficiency, and are determined according to a variety of considerations, including communications-media error rates, buffering capacity of network devices, data rates supported by the communications media, and other considerations.

FIG. 8B shows a first step in the data transfer according to a networking system that represents one embodiment of the present invention. An application program, system routine, or other computational entity within the first computer requests transfer of the data file 806 to the second computer 804 through a data-transfer interface. The networking system that represents one embodiment of the present invention allocates a sequence-descriptor-cache entry 812 that represents the state of a sequence, essentially a network connection established to transfer the data file 806. The term “sequence” is used in the present discussion similarly to the use of the term “connection” in the descriptions of current networking protocols and systems. The cache entry is allocated from a cache of sequence descriptors stored in the memory of the first computer. The sequence descriptor includes a sequence identifier 813, a most recently completed packet-run number, or most recently completed sequence number 814, the highest-sequence-numbered packet sent 815, and a bit map 816 indicating ACK status of those sent packets greater than the highest completed sequence number (814). In other words, the bit map 816 describes the ACK status of packets numbered from completed-sequence-number+1 to highest-sent sequence number. In FIG. 8C, the sequence descriptor 812 is initialized to reflect an initial sequence state. The sequence identifier 813 has the value “36,” a value generated to, when combined with the destination identifier or address of the receiving computer, form a unique identifier of the sequence with respect to the sequences in which the first and second computers currently participate. Sequence identifiers are discussed further, below. The recently completed packet-run number 814 has the value “0,” since ACKs have not been received for a run of one or more consecutive packets. The highest-sequence-numbered packet sent 815 has the value “0,” since no data packets have yet been transmitted. The bit map 816 contains only “0” entries, since no ACKs have yet been received.

Next, as shown in FIG. 8C, the network system that represents one embodiment of the present invention transmits the first data packet 818 to the second computer 804, updating the highest-sequence-numbered packet of the cache entry, or sequence descriptor 812, to indicate that the number “1” is the highest-sequence-numbered packet sent. As shown in FIG. 8D, the first networking system that represents one embodiment of the present invention sends a second data packet 819 from the first computer to the second computer 804. The sequence descriptor 812 is again updated to reflect transmission of the second packet. In FIG. 8D, both the first packet 818 and the second packet 819 are shown in transit, having not yet arrived at the second computer 804.

FIG. 8E shows the state of the data-file transmission at a subsequent point in time, following reception of the first packet by the second computer 804 and transmission of a third data packet 822 by the first computer 802. Upon receiving the first packet, the second, or receiving, computer allocates and initializes a sequence descriptor 824 within a sequence-descriptor cache on the second computer. The sequence descriptor includes the sequence identifier 826 of the data sequence, an indication of the sequence number of a highest-sequence-numbered packet received without any preceding missing packets 826, or sequence number of the current watermark for successful data transmission, and a bit map 828 showing reception status of data packets with sequence numbers greater than the watermark sequence number 826. The sequence descriptor 824 in FIG. 8E thus indicates that the sequence identified by the sequence identifier 36 has been established and a first packet has been received for the sequence. The bit map contains only “0” bits, representing packets 2-5, none of which have been received. The received packet is transferred to memory 830 by the second computer. Sequence descriptor 812 has again been updated by the first computer to reflect that three data packets have been sent, without any ACKs received.

In FIG. 8F, because of different paths through which the second and third data packets have been routed, the ordering of the second 819 and third 822 data packets has been reversed. In other words, the data packets have been re-ordered during network transmission. In addition, the first ACK returned by the second computer to the first computer has been received by the first computer and the sequence descriptor accordingly updated. Note that the highest-completed-sequence number 814 has been incremented to reflect the fact that the first ACK corresponding to the first data packet has been received and that the bit map 816 has been shifted leftward by one position, with the two “1” bit values representing the second and third packets that have been sent, but for which ACKs have not yet been received.

In FIG. 8G, the third data packet has been received by the second computer 804 and the sequence descriptor 824 accordingly updated. An ACK for the third data packet 830 has been transmitted by the second computer to the first computer and the first computer has transmitted the fourth data packet 832 and accordingly updated the sequence descriptor 812. Note that sequence numbers in the data-packet headers allow the data contents of a packet received out of order to nonetheless be written properly to memory.

In FIG. 8H, the second computer 804 has received the third data packet and has accordingly updated the sequence descriptor 824 and has returned an ACK for the second packet 834 to the first computer 802. The first computer has received the ACK for the third data packet and accordingly updated the sequence descriptor. Note that the second bit in the bit map 836 is set to “0” to indicate that an ACK has been received for the third data packet.

In FIG. 8I, the second computer 804 has received the final data packet and accordingly updated the sequence descriptor 824, returning an ACK 840 to the first computer 802 for the fourth packet. The first computer has received the ACK for the second data packet and accordingly updated the sequence descriptor 812. Note that the bit map 816 has been left-shifted by two positions and the highest-completed-sequence number 814 has been incremented by two.

In FIG. 8J, the first computer has received the ACK for the fourth data packet and accordingly updated the sequence descriptor 812. Because the sequence is now idle, and no longer needed by the first computer, the first computer may elect to delete the sequence by, as shown in FIG. 8K, sending a delete request 860 to the second computer 804. Upon receiving the delete request, as shown in FIG. 8L, the second computer 804 removes the sequence descriptor from its cache and returns an ACK message 862 to the first computer 802. As shown in FIG. 8M, upon receiving the ACK message (862 in FIG. 8L), the first computer 802 deletes the sequence identifier from its cache of sequence identifiers.

FIGS. 8A-M illustrate a simple, example data transmission by the networking system that represents one embodiment of the present invention. The networking system that represents one embodiment of the present invention may be used for a variety of different high-level tasks, including data transmission, but also including transmitting various types of commands and exchanging other types of information. The semantics and high-level protocols for the high-level operations may be incorporated into embodiments of the networking system of the present invention. For example, for certain types of operations, operations received multiple times may be repeated, while other types of operations can only be executed once by the receiving computer. In such cases, the networking system, upon detecting duplicate data-packet transmission, may further determine the type of operation represented by the data packet and accordingly either repeat execution of the operation and return an ACK message or return an ACK, without repeating execution of the operation, depending on the semantics of the operation. In the simple example shown in FIGS. 8A-M, a truncated version of the cache entries is shown, for clarity. While the highest-completed-sequence number and highest-transmitted-sequence number, along with a bit map, can be used to describe the transmission and ACK states of data packets on the sending-computer side, as shown in FIG. 8A-M, other techniques may be employed for tracking sent messages and received acknowledgments. Similarly, alternative methods may be employed on the receiving computer side.

Networking systems that represent embodiments of the present invention have low overhead for creating and destroying connections. As shown in FIGS. 8A-E, a connection is established in addition to transmission of a first data packet and return of a single ACK message. In essence, there is almost no time or computational overhead for establishing the connection. A connection can be removed by transmission of an explicit, separate delete-connection request, shown in FIG. 8K, but may also be removed by including a connection-removal indication in the header of the last data packet sent. The amount of state information stored in the sequence descriptors, or cache entries, on the sending and receiving computers is relatively small, including only a handful of fields, described below. Because of the low overhead, a far greater number of connections can be maintained by the networking system that represents one embodiment of the present invention than by traditional networking systems for a given capacity. Because the time and computational overheads for establishing and deleting connections are relatively small in the networking systems that represent embodiments of the present invention, there is little penalty for establishing connections just long enough to send one or a few data packets. Therefore, under high network-communications load in a large, distributed system, connections may be transient, established on demand at the time communications is needed between a pair of nodes and deleted immediately after a small amount of data has been transferred. Low-overhead connections increase the interconnection capacity of a networked system, because, in general, at any given time, only a relatively small subset of nodes needs to communicate with one another, and connections need exist only for that subset of communication nodes at each point in time. In other words, the nodes may be fully interconnected, according to the networking system that represents one embodiment of the present invention, with respect to potential communication between all pairs of nodes, but, at any given point in time, the networking system needs only to maintain those connections used, at that point in time, for internode communication.

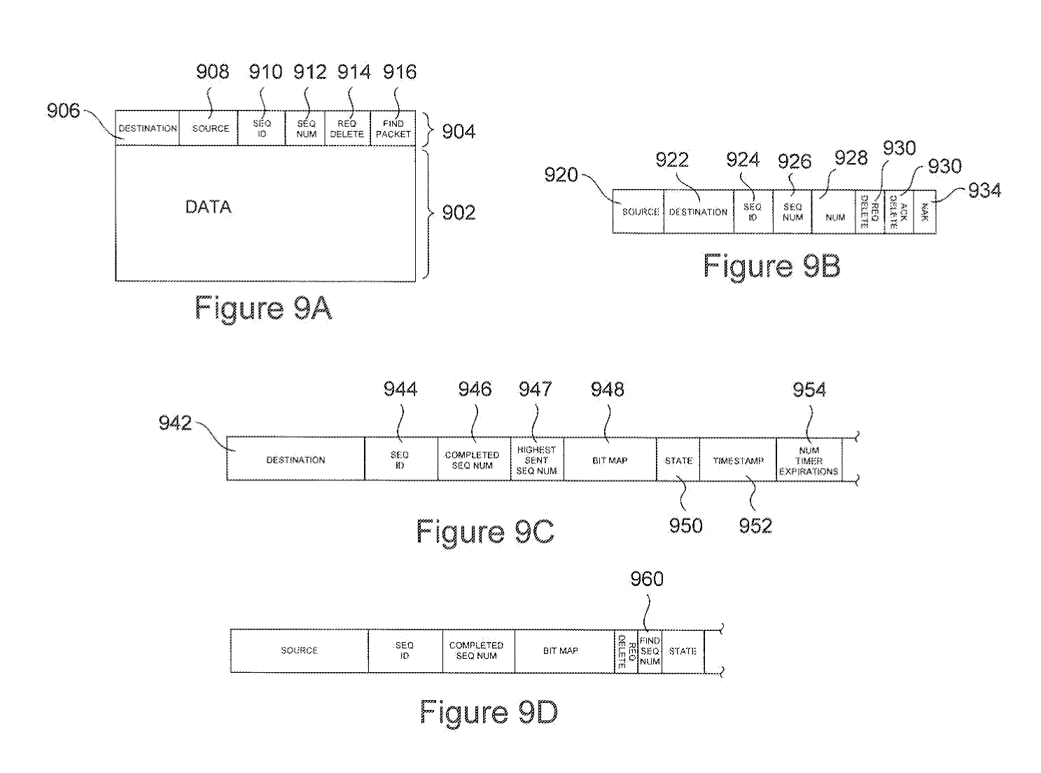

FIGS. 9A-D illustrate data structures employed by the networking system that represents one embodiment of the present invention. The data structures are one example of the data structures that may be employed in various embodiments of the present invention. FIG. 9A illustrates the data packets transmitted between nodes according to one embodiment of the present invention. The data packets include data 902 and a header 904 comprising the following fields: (1) a destination address or identifier 906; (2) a source identifier or address 908; (3) a sequence identifier 910; (4) a sequence number 912; (5) a delete-request flag 914; and (6) a final-packet-indication flag 916. The sequence identifier, in combination with the destination identifier or address, uniquely identifies the sequence with respect to the sending computer, and combined with the source identifier or address, uniquely identifies the sequence with respect to the receiving computer. A sequence number 912 is the position of the data packet within the sequence of data packets. The request-delete flag 914, when set, indicates that the connection should be removed. The final-packet flag 916 indicates that the current packet is the final packet in a logical sequence of packets that comprise a file, command, or other logical data entity.

FIG. 9B illustrates fields within an example ACK message. These fields include: (1) a source identifier or address 920; (2) a destination identifier or address 922; (3) a sequence identifier 924; (4) a sequence number 926; (5) an indication of the number of contiguous sequence numbers, ending in the current sequence number shown in field 926, that are being ACK'd by the ACK 928; (6) a delete request flag 930; (7) an ACK-delete flag 932; and (8) a NAK flag 934. The source and destination fields 920 and 922 provide for proper routing of the ACK message, as for data packets in the data-packet header shown in FIG. 9A. The sequence identifier and sequence number fields 924 and 926 identify the sequence, or connection, and the highest-sequence number of a group of data packets including the number of data packets indicated by field 928 that are being acknowledged by the ACK. The request-delete flag indicates that the receiving computer is requesting that the connection, or sequence, be deleted. The delete-ACK flag 932 indicates that the ACK message is acknowledging a delete request by the sending computer. Finally, the NAK flag 934 indicates, when set, that a connection request is being refused by the receiving computer.

FIG. 9C illustrates a cache entry employed by the sending computer as a sequence descriptor, as discussed above with reference to FIGS. 8A-M. The sequence descriptor 940 includes an address or identifier for the receiving computer 942, the sequence identifier 944, the highest-completed-sequence number 946, highest-sent-sequence number 947, and a bit map 948 discussed above with reference to FIGS. 8A-M, as well as additional fields that indicate the state of the sequence 950, an optional time stamp 952 that may be used to remove oldest, idle connections by a monitoring process, and an indication of the number of timer expirations that have occurred with respect to the sequence 954. The sequence identifier, or cache entry, employed by the receiving computer is shown in FIG. 9D, and includes fields similar to those in the sending-computer sequence descriptor, shown ion FIG. 9C, with the addition a final-sequence-number field 960 that indicates the sequence number of the final data packet, used when the final data packet is received prior to earlier transmitted data packets.

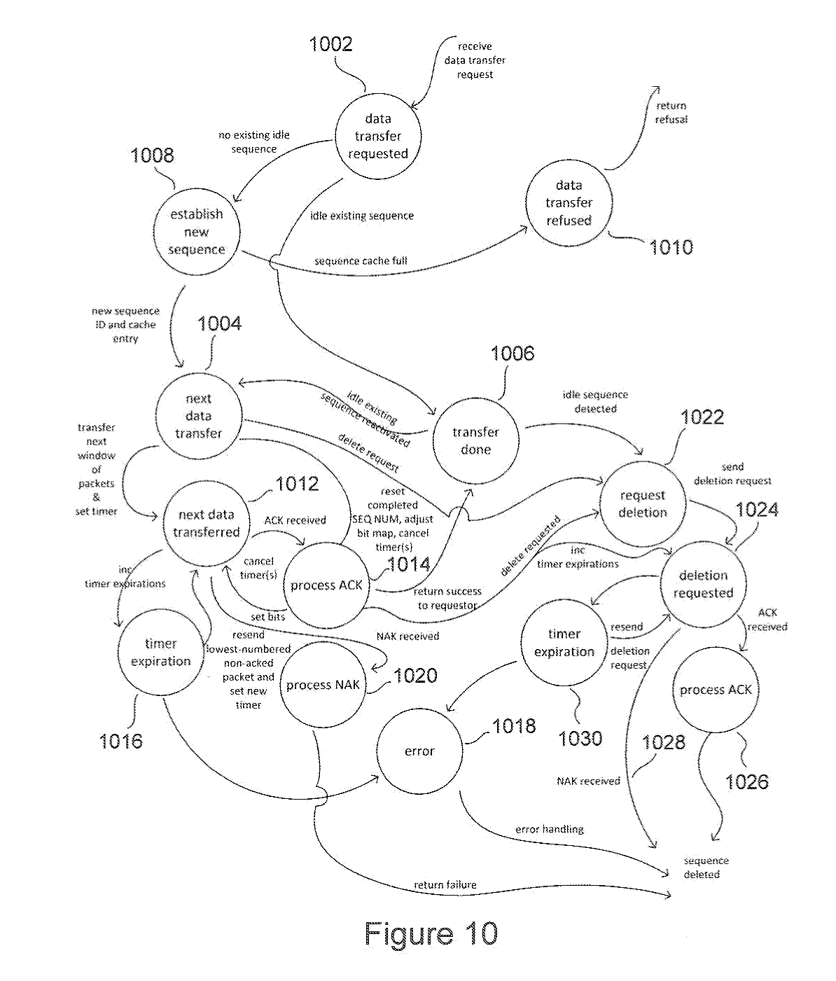

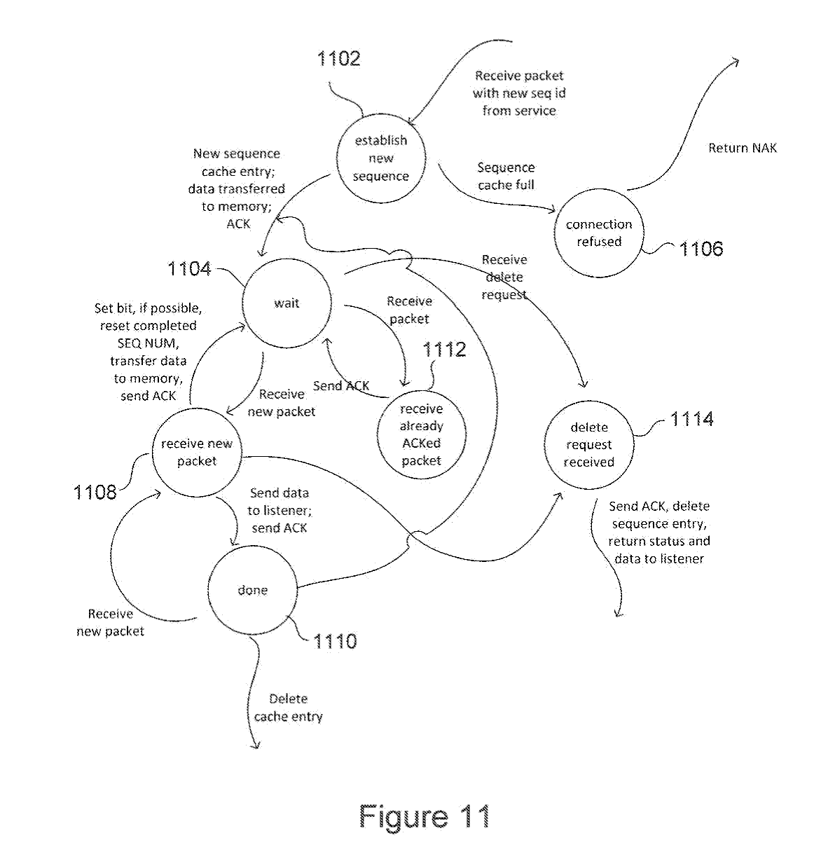

FIGS. 10 and 11 provide state-transition diagrams that describe one embodiment of the networking system of the present invention. These state-transition diagrams are examples of the many possible state-transition diagrams that may be created to describe various embodiments of the present invention. FIG. 10 shows a state-transition diagram for the sending computer. It should be noted, at the onset, that the state transition diagram shown in FIG. 10 describes transitions associated with a single sequence or connection. In any given computer system, there may be many hundreds, thousands, or millions of concurrent connections, or sequences, including multiple sequences that interconnect a given pair of nodes.

A first data-transfer-requested state 1002 is entered when a data-transfer request is received through an application or system interface by the networking system that represents one embodiment of the present invention. When there already exists an idle sequence interconnecting the sending computer with the receiving computer, the sequence state transitions to the next-data-transfer state 1004 via a transfer-data state 1006. Otherwise, the sequence state transitions to an establish-new-sequence state 1008. When the sequence-descriptor cache is full, the sequence state transitions to a data-transfer-refuse state 1010, which terminates the sequence upon return of a refusal through the application or system interface to the data-transfer requestor. Otherwise, a new sequence ID is generated for the sequence and a cache entry allocated and initialized for the sequence prior to transition to the next-data-transfer state 1004. The sequence state transitions from the next-data-transfer state 1004 to the next-data-transfer state 1012 upon transmission of a next window of data packets by the sending computer to the receiving computer. A window of data packets may be defined by, for example, the length of the bit map contained in the sequence descriptor or cache entry. When an ACK is received, the sequence state transitions to the process-ACK state 1014. When the sequence number acknowledged by the ACK represents a highest-sequence number of a contiguous set of sequence numbers corresponding to acknowledged packets starting from the highest-completed-sequence number in the sequence descriptor, then the sequence descriptor is appropriately updated to reflect a new highest-completed-sequence number and the bit map left shifted, providing additional window slots for additional packet transmissions, and the sequence state transitions back to the next-data-transfer state 1004. Otherwise, the sequence descriptor bit map is updated to reflect the ACKed data packets and the sequence state transitions back to the next-data-transfer state 1012. When a timer expires, the sequence state transitions to the timer-expiration state 1016. When the number of timer expirations sequence has not exceeded some maximum threshold number, the lowest-numbered, non-acknowledged packet is resent, a new timer is set, and the sequence state transitions back to the next-data-transfer state 1012. Otherwise, the sequence state transitions to an error state 1018. When a NAK is received, the sequence state transitions to the process-NAK state 1020, which causes a data-transfer failure to be returned to the application or system interface back to the requestor and the sequence deleted. When, during processing of an acknowledgement message, it is determined that all data packets have been sent and acknowledged, the sequence state transitions to the transfer-done state 1006, representing an idle sequence. However, in certain cases, the sequence state may instead transition to the request-deletion state 1022, in the case that the sending computer needs to reclaim the cache entry immediately, rather than allow the sequence to remain idle, or to the deletion-requested state 1024 in the case that the sending computer has indicated, in the last data packet sent to the receiving computer, that the sequence should be deleted by setting the request-delete flag (930 in FIG. 9B).

The transfer-done state 1006, discussed above, represents an idle sequence. As discussed above, an idle sequence may be re-used for a new data-transfer request. However, because a sequence-descriptor cache is generally limited, particularly in the large, highly interconnected, distributed systems in which the networking system that represents one embodiment of the present invention is particularly useful, the sending computer may execute a separate monitoring process to detect and delete idle sequences when the sequence-descriptor cache contains a number of sequence descriptors equal to or greater than a threshold number. This monitoring process may initiate a deletion request, in which case the sequence state transitions to the request-deletion state 1022. A deletion-request message is sent to the receiving computer, resulting in a transition from the request-deletion state 1022 to the deletion-requested state 1024. When the deletion request is acknowledged, the state of the sequence transitions from the deletion-requested state 1024 to the process-ACK state 1026, in which state the sequence is deleted. Should, instead of an ACK, a NAK be received, the sequence is also deleted, as shown by arrow 1028 in FIG. 10. Should a timer expire with respect to the deletion request, the state transitions to the timer-expiration state 1030, from which the state returns to the deletion-requested state by re-sending the deletion request, when the number of timer expirations is below a threshold number, and otherwise transitions to the error state 1018 when a number of timer expirations equal to or greater than a threshold number have occurred. Various types of error-handling mechanisms may be employed to transition from the error state 1018 to sequence deletion.

FIG. 11 provides an example state-transition diagram for the receiving computer for a particular sequence. The establish-new-sequence state 1102 is entered when the receiving computer receives a packet with a new sequence identifier/source pair for which a sequence descriptor cannot be found in the receiving computer's sequence-descriptor cache. The sequence state transitions from the establish-new-sequence state 1102 to the wait state 1104 following allocation and initialization of a sequence descriptor for the new sequence and return of an ACK to the sending computer. However, when the sequence-descriptor cache is full, the state transitions to the connection-refused state 1106, from which the sequence is terminated by returning a NAK message to the sending computer. When a new data packet is received, the state of the sequence transitions to the receive-new-packet state 1108. When a new packet is not the final packet for the data transfer, the sequence descriptor is updated and an ACK message is returned to the sending computer, with the state transitioning back to the wait state 1104. However, when all of the data packets have been received, as determined by accessing the sequence descriptor or by the final-packet flag being set in the header of the received data packet, then the state transitions to the done state 1110. The sequence is essentially idle, in the done state 1110. A sequence may be re-used, if a new data transfer is initiated from the sending computer while the sequence remains idle, in which case the state transitions to the wait state 1104 after updating the sequence descriptor and returning an ACK to the sending computer. Otherwise, the sequence may be deleted either as a result of reception of an explicit delete request from the sending computer or sending of a deletion request from the receiving computer to the sending computer and reception of an acknowledgement by the sending computer. In the case that a repeated reception of a data packet occurs, the state transitions from the wait state 1104 to the receive-already-ACKed-packet state 1112. The packet is ACKed, resulting in transition back to the wait state 1104. The receiving computer can either discard the redundant packet, or repeat whatever data transfer or demand is represent by the packet, depending on the semantics of the operation carried out by, or that results from, the data transfer. At any point in time, even prior to completion of the data-transfer operation, a delete request may be received from the sending computer, in which case the state transitions from the wait state 1004 or the receive-new-packet state 1108 to the delete-request-received state 1114, from which state the sequence is deleted, following sending of an ACK by the receiving computer to the sending computer and optional return of a termination status and incomplete data to the listening application on the receiving computer, in the case that semantics of the higher-level operation accommodate incomplete or truncated transfer operations.

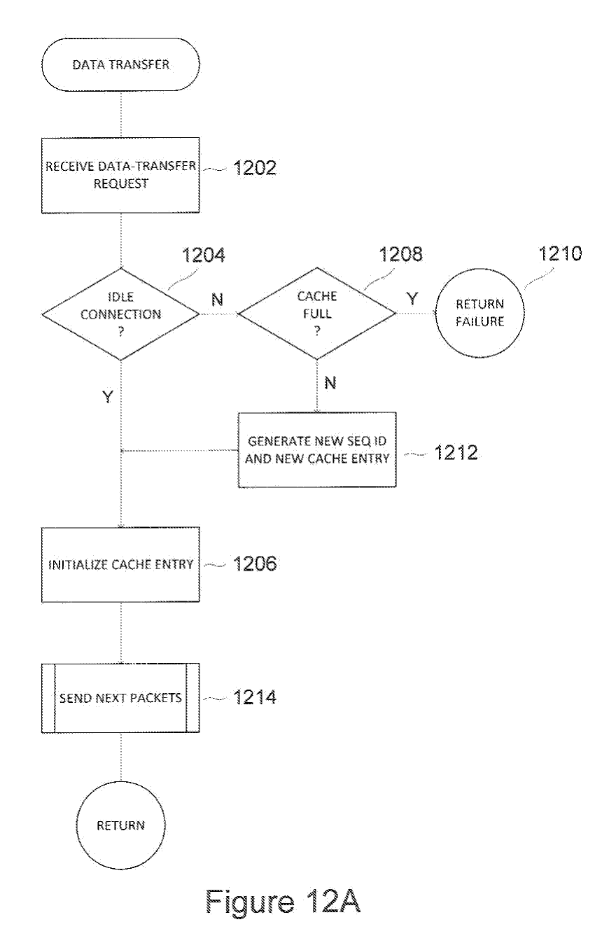

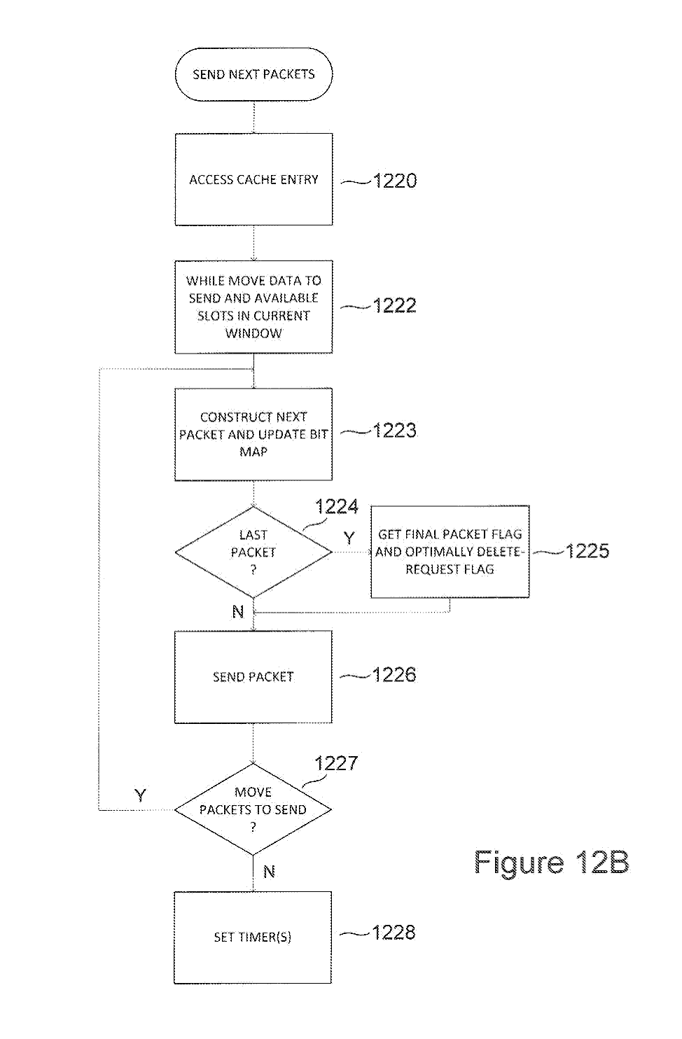

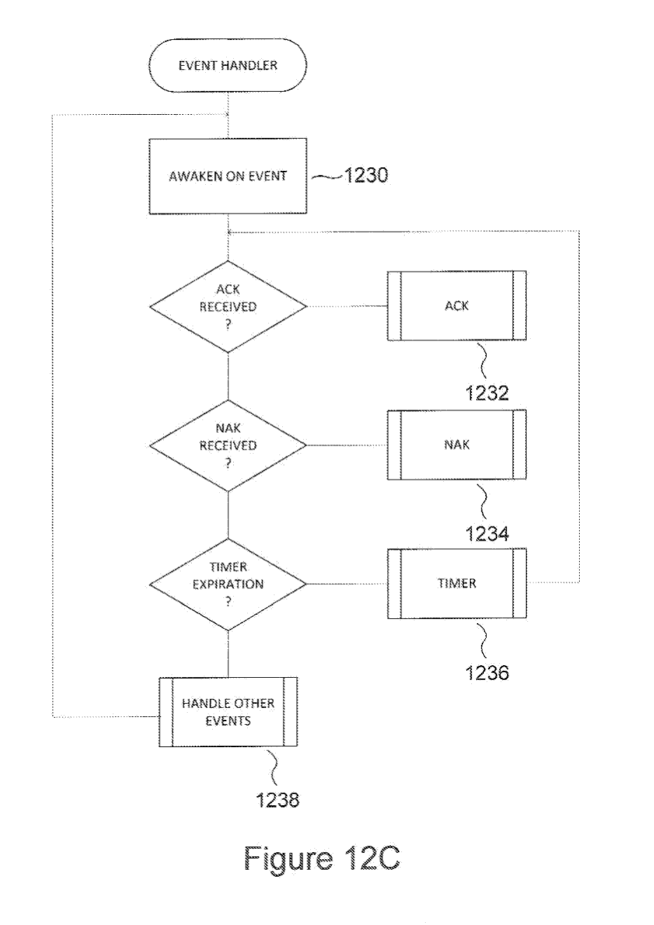

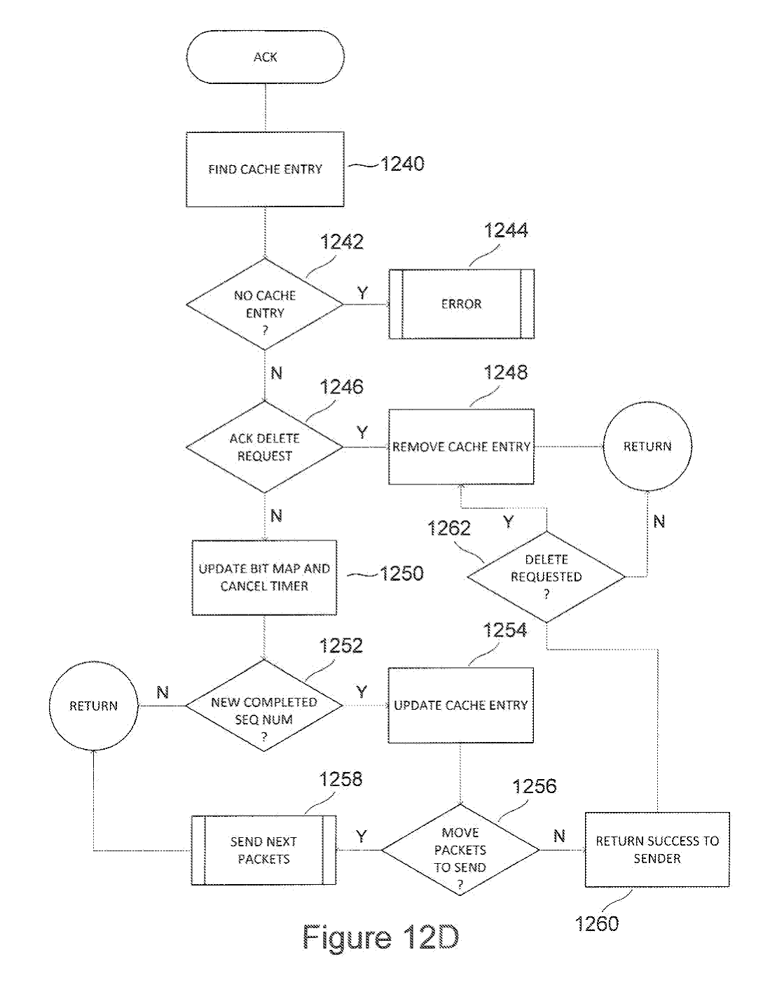

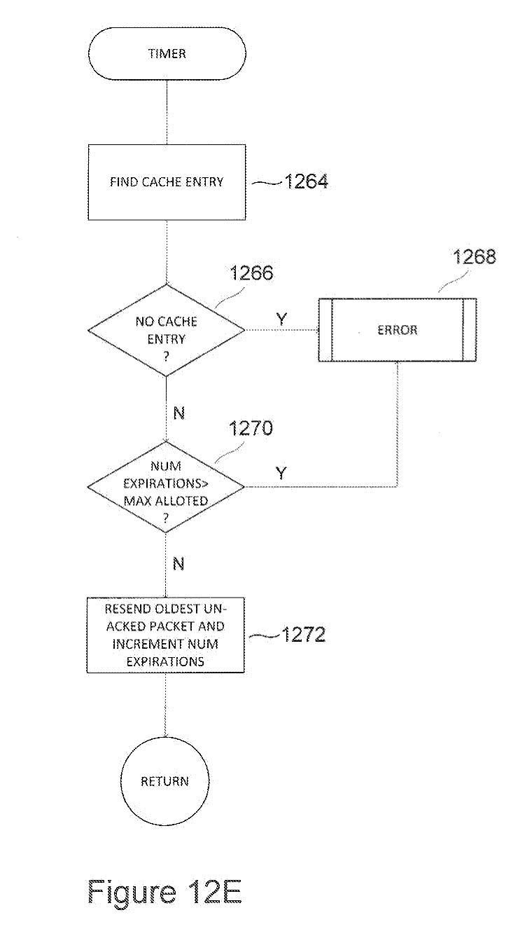

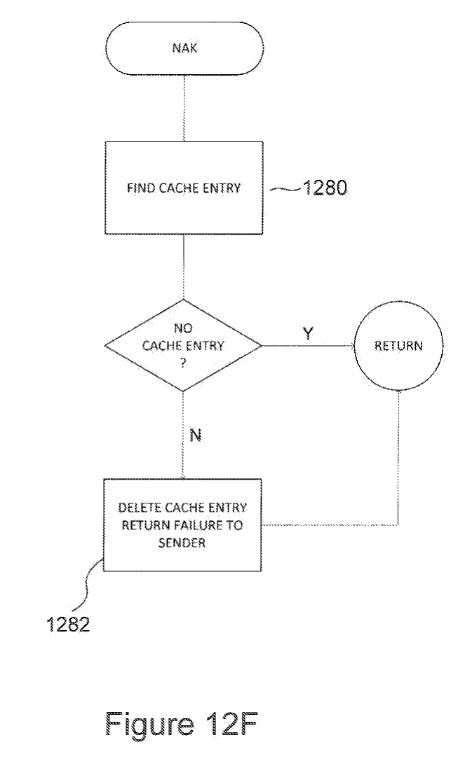

FIGS. 12A-F provide control-flow diagrams for one server-side embodiment of the networking system of the present invention. These control-flow diagrams are examples of many possible embodiments of the present invention. FIG. 12A provides a control-flow diagram for the routine “data transfer.” The phrase “data transfer” is a general phrase that includes both traditional data-transfer operations, such as file-transfer operations, as well as transfer of commands and other types of information according to higher-level protocols. Furthermore, networking protocols that represent embodiments of the present invention may be employed at levels within computer systems or other electronic devices below application programs, such as distributed-memory-sharing routines within operating systems and even hardware components of electronics communications devices.

In step 1202, a data-transfer request is received by the networking system that represents one embodiment of the present invention through an application or systems interface. When there is an idle sequence available, as determined in step 1204, that connects the sending computer with the receiving computer, then the cache entry or sequence descriptor for the idle connection is re-initialized in step 1206. Otherwise, when the cache is full, as determined in step 1208, a data-transfer-request failure is returned in step 1210 to the requestor. Otherwise, a new sequence-descriptor is allocated within the cache and a new sequence ID generated and inserted into the cache entry, in step 1212, prior to initialization of the other fields of the cache entry in step 1206. Sequence identifiers are generated so that the destination-computer identifier or address, when concatenated with the new sequence identifier, forms a unique identifier of the new sequence for the sending computer and the source-computer identifier or address, when concatenated with the new sequence identifier, forms a unique identifier of the new sequence for the receiving computer. One method for achieving this is to associate each destination computer with a 64-bit or 128-bit, monotonically increasing next-sequence-identifier value. However, using monotonically increasing sequence numbers may represent a vulnerability to certain types of protocol attacks. Alternatively, the next sequence identifier may be generated from the monotonically increasing next-sequence number value by an additional operation, such as by using the next sequence identifier value as a seed value for a pseudo-random number generator that is guaranteed to produce a unique pseudo-random number for each different seed value. Once the cache entry is initialized, the send-next-packets routine is called, in step 1214, to send an initial window of data packets to the receiving computer.

FIG. 12B provides a control-flow diagram for the routine “send next packets,” called in step 1214 of FIG. 12A. In step 1220, the sequence descriptor for the sequence is accessed to determine the next data packets to be sent. As discussed above, in general, the sending computer can send up to some maximum number of packets that constitutes a next window of data packets. The window may constitute, as one example, the number of “0” bits in the bit map within the sequence descriptor. Then, in the while-loop comprising steps 1222-1227, a next data packet is constructed, in step 1223, and sent in step 1226 while there remain additional data packets to send and while there remain available slots in the current window of data packets. In the case that the last data packet of a data transfer is being sent, as detected in step 1224, a final-packet flag is set in the data-packet header and, should the sending computer wish to immediately delete the sequence following successful data transfer, the delete-request flag may additionally be set in the data-packet header in step 1225. Finally, in step 1228, a timer is set for each packet or, in alternative embodiments, for the entire window of packets transmitted in the while-loop of steps 1222-1227.

FIG. 12C shows the routine “event handler.” The routine “event handler” is a general event-handling routine that runs on the sending computer to handle all network-system-related events. The handler routine is awakened, in step 1230, upon the occurrence of various different types of events, including reception of ACK and NAK messages and timer expirations. Each type of event is handled by a call to an appropriate event-handling routine, including the ACK routine 1232, the NAK routine 1234, and the timer routine 1236. A catch-all event handler 1238 is included to handle all other network-system-related events.

FIG. 12D provides a control-flow diagram for the ACK routine, called in step 1232 of FIG. 12C. First, the cache entry, or sequence descriptor corresponding to the ACK message is found in the sequence-descriptor cache, in step 1240. When there is no cache entry, as determined in step 1242, then an error condition obtains, in step 1244. Otherwise, when the ACK message is an ACK message corresponding to a delete request, as determined in step 1246, then the sequence descriptor is removed from the cache, in step 1248 and the routine terminates. Otherwise, the sequence descriptor bit map and other values are updated according to the data packets that are being acknowledged, and the appropriate timer or timers are cancelled, in step 1250. When a new set of completed ACKs that comprises a new completed sequence run is detected in the bit map, as determined in step 1252, then the completed sequence value in the sequence descriptor is updated and the bit map accordingly left-shifted, in step 1254. When there are more packets to send, as determined in step 1256, the routine “send next packet” is called in step 1258. Otherwise, a data-transfer success status is returned to the requesting application or system routine, in step 1260 and, when a delete was requested in the last transmitted data packet, as determined in step 1262, the cache entry is removed in step 1248.

FIG. 12E provides a control-flow diagram for the routine “timer,” called in step 1236 of FIG. 12C. The sequence descriptor or cache entry for the sequence for which a timer has expired is found in step 1264. When there is no sequence descriptor, as determined in step 1266, an error obtains in step 1268. Otherwise, when the number of expirations is greater than the maximum allowed timer expirations for the sequence, as determined in step 1270, an error also obtains in step 1268. Otherwise, the oldest unacknowledged data packet is resent in step 1272, and the number of timer expirations is updated in the sequence descriptor.

FIG. 12F provides a control-flow diagram for the routine “NAK.” In step 1280, the sequence descriptor for the sequence is found in the cache. When there is no cache entry, the routine simply returns. Otherwise, the cache entry for the sequence is deleted and failure is returned to the data-transfer-operation requestor, in step 1282.

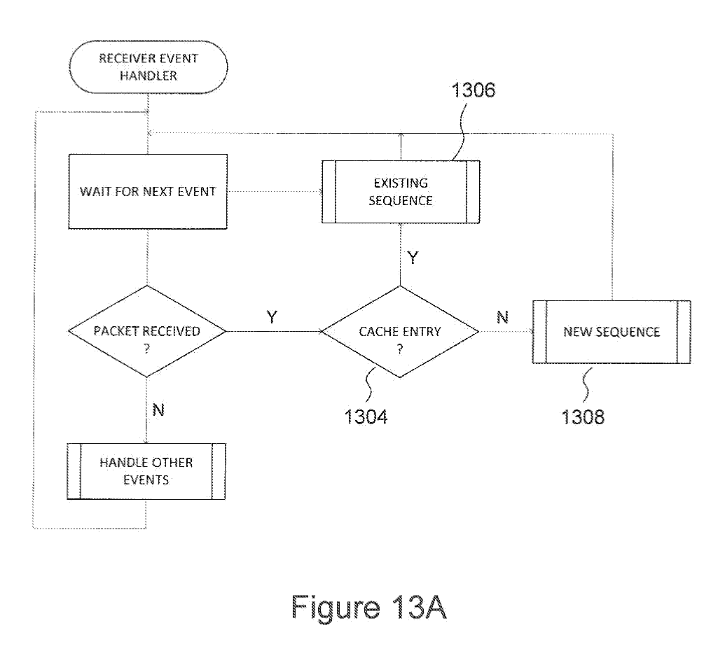

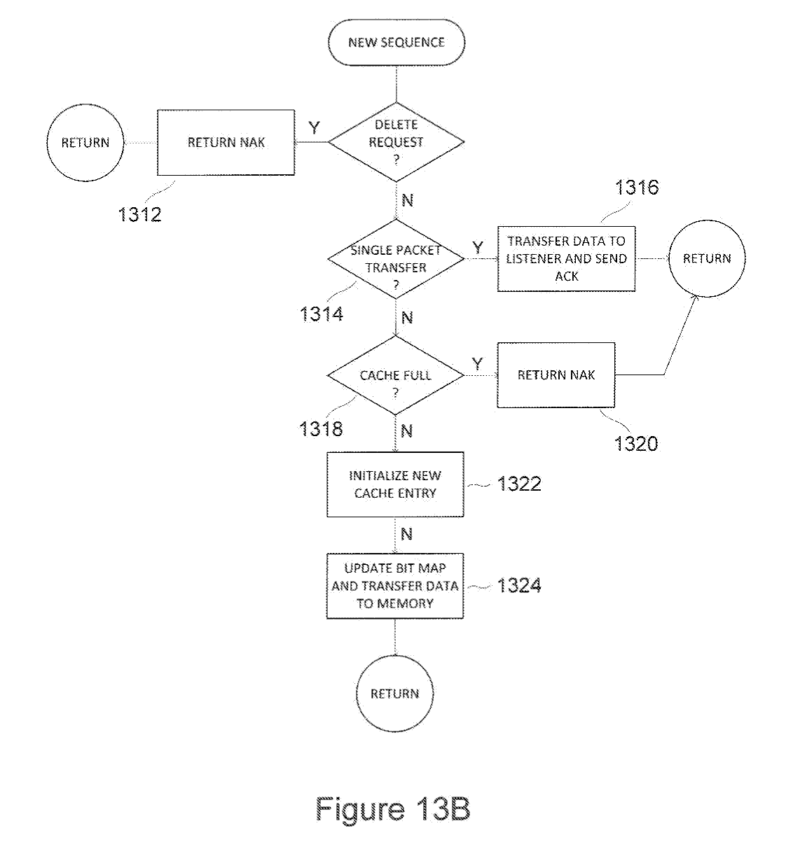

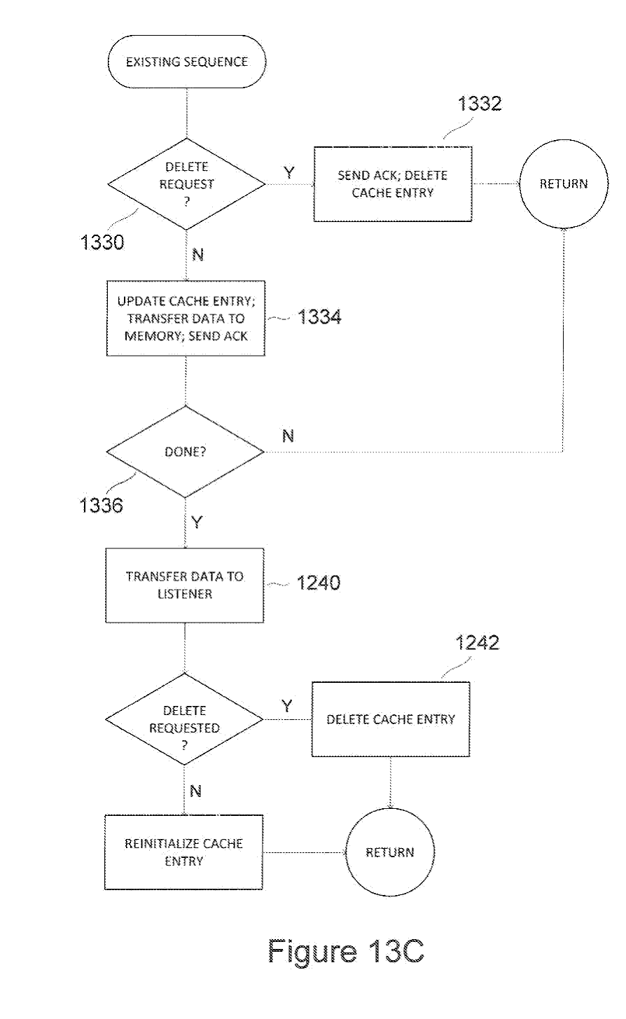

FIGS. 13A-C provide control-flow diagrams for one receiving-side embodiment of the networking system of the present invention. These control-flow diagrams are examples of many possible embodiments of the present invention. The receiving computer responds to network-related events in an event loop, shown in FIG. 13A. When the next packet is received, and when there is a cache entry for the sequence already in the cache, as determined in step 1304, the routine “existing sequence” is called in step 1306. Otherwise, the routine “new sequence” is called in step 1308.

FIG. 13B provides a control-flow diagram for the routine “new sequence,” called in step 1308 of FIG. 13A. When the received packet is a delete request, as determined in step 1310, then a NAK is returned to the sender in step 1312. Otherwise, when the data packet has the final-packet flag set, as determined in step 1314, indicating a single-data-packet data-transfer operation, then the data is transferred to the listener application or system routine, in step 1316, and an ACK is returned to the sending computer. In this case, there is no need to allocate and initialize a cache entry. Otherwise, when the sequence-descriptor cache is full, as determined in step 1318, then a NAK is returned to the sending computer in step 1320. Otherwise, a new cache entry is allocated and initialized, in step 1322 and the bit map and other fields in the sequence descriptor are updated and data in the packet transferred to memory in step 1324.

FIG. 13C provides a control-flow diagram for the routine “existing sequence,” called in step 1306 of FIG. 13A. When the received packet is a delete request, as determined in step 1330, then an ACK is returned to the sender and the cache entry for the sequence deleted, in step 1332. Otherwise, the sequence descriptor is updated for the sequence and any data in the packet is transferred to memory, and an ACK message is returned to the sending computer. When the data transfer is complete, as determined in step 1336, which can be determined from the sequence number of a final data packet with the final-packet flag set, stored in the final-sequence-number field of the cache entry and other fields of the sequence descriptor, when the final data packet is received out of sequence order, or from reception of the final data packet when received in sequence order, the data is transferred from memory to the listener in step 1240 and the cache entry may be deleted, in step 1242, when the delete-requested flag is set in the final data packet. Note that, in step 1332, partial data may be returned to a listener application or system routine in the case of termination of a sequence prior to completion of the data transfer, in certain cases, as discussed above.

Although the present invention has been described in terms of particular embodiments, it is not intended that the invention be limited to these embodiments. Modifications will be apparent to those skilled in the art. For example, the networking system embodiments of the present invention may be implemented in many different ways by varying standard implementation parameters, including modular organization, data structures, control structures, programming language, and other such implementation parameters, to execute on many different types of computers and other electronic devices, including cell phones and components of computer systems. The networking systems that represent certain embodiments of the present invention may alternatively be implemented in hardware, logic circuits, firmware, or a combination of software, firmware, and hardware. The networking system includes the sequence descriptor caches stored in electronic memories, the packet-exchange protocol, and other aspects of the networking systems that represent embodiments of the present invention, discussed above, as well as the various software and hardware layers within a computer or other electronic device that implement physical data exchange. While many of the hardware layers may be used for multiple different types of networking systems, and are not specific to a given networking system, and it should be appreciated that networking systems are not abstract descriptions, but are instead portions of data-transfer facilities that necessarily execute on computers and other electronic devices. As discussed above, mechanisms for packet reordering, data structures employed as sequence descriptors, packet headers, and other details may vary, from implementation to implementation. However, as discussed above, all of the implementations of the present invention are characterized by small computational, time, and memory overheads for establishing and deleting connections between pairs of communicating nodes.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A networking system comprising:
a sending device;
a receiving device;
electronic communications components and transmission media through which the sending device and receiving device exchange data packets; and
a networking protocol implemented in executable routines, firmware, hardware, or a combination of two or more of executable routines, firmware, hardware that provides for transmission of data in an ordered set of data packets through a sequence established between the sending device and receiving device as a result of transmitting a first data packet from the sending device to the receiving device and returning an acknowledgement by the receiving device to the sending device.

2. The networking system of claim 1 wherein the networking protocol provides for reliable and accurate transmission of data in an ordered set of data packets despite packet duplication, packet reordering, and packet losses during transmission of the ordered set of data packets through the electronic communications components and transmission media.

3. The networking system of claim 1 wherein a sequence comprises:
a sending-device sequence descriptor stored in a sequence-descriptor cache in a memory of the sending device; and
a receiving-device sequence descriptor stored in a sequence-descriptor cache in a memory of the receiving device.

4. The networking system of claim 3 wherein the sending-device sequence descriptor includes:
a sequence-identifier field;
a receiving-device-identifier-or-address field;
a highest-completed-sequence-number field;
a highest-transmitted-sequence-number field; and
a bit map.

5. The networking system of claim of claim 4 wherein:
the values stored in the sequence-identifier field and receiving-device-identifier-or-address field together uniquely identify the sequence among all sequences in which the sending device participates;
the highest-completed-sequence-number field stores a value that identifies the sequence number of the data packet that constitutes the final data packet of an ordered subset of data packets transmitted through the sequence and acknowledged by the receiving device that includes the first transmitted data packet of the current data-transfer operation;
the highest-transmitted-sequence-number field stores a value that indicates the largest sequence number associated with a data packet transmitted to the receiving device by the sending device during the current data-transfer operation; and
the bit map indicates, for each data packet with a sequence number greater than the value stored in the highest-completed-sequence-number field and less than or equal to the value stored in the highest-transmitted-sequence-number field, whether or not the data packet has been acknowledged.

6. The networking system of claim 3 wherein the receiving-device sequence descriptor includes:
a sequence-identifier field;
a sending-device-identifier-or-address field;
a highest-completed-sequence-number field;
a final-sequence-number field; and
a bit map.

7. The networking system of claim of claim 4 wherein:
the values stored in the sequence-identifier field and sending-device-identifier-or-address field together uniquely identify the sequence among all sequences in which the receiving device participates;
the highest-completed-sequence-number field stores a value that identifies the sequence number of the data packet that constitutes the final data packet of an ordered subset of data packets received through the sequence and acknowledged by the receiving device that includes the first transmitted data packet of the current data-transfer operation;
the final-sequence-number field stores a value that indicates the largest sequence number associated with a data packet in the current data-transfer operation; and
the bit map indicates, for each data packet with a sequence number greater than the value stored in the highest-completed-sequence-number field and less than or equal to the value stored in the final-sequence-number field, whether or not the data packet has been received and acknowledged.

8. The networking system of claim 3 wherein a data-transfer request is refused by the networking protocol on the sending device when a new sequence descriptor cannot be allocated from the sequence-descriptor cache and no idle sequence that connects the sending device and receiving device is available.

9. The networking system of claim 3 wherein the receiving device refuses to establish a sequence upon receiving a first packet of the sequence when a new sequence descriptor cannot be allocated from the sequence-descriptor cache and no idle sequence that connects the sending device and receiving device is available.

10. The networking system of claim 3 wherein, when the networking protocol on the sending device receives a data-transfer request from an application program or system routine, the networking protocol allocates and initializes a new sequence descriptor for the sequence, when there is no idle sequence that interconnects the sending device and receiving device, and otherwise reinitializes an idle sequence, and transmits a first data packet of the data-transfer operation corresponding to the data-transfer request to the receiving computer.

11. A method that establishes a sequence between a sending device and a receiving device interconnected by electronic communications components and transmission media through which the sending device and receiving device exchange data packets, the method comprising:
storing a sending-device sequence descriptor, by the sending device, in a sequence-descriptor cache in a memory of the sending device transmitting a first data packet from the sending device to the receiving device;
receiving the first data packet by the receiving device;
storing a receiving-device sequence descriptor, by the receiving device, in a sequence-descriptor cache in a memory of the receiving device; and
returning an acknowledgement by the receiving device to the sending device.

12. The method of claim 11 wherein the sending-device sequence descriptor includes:
a sequence-identifier field;
a receiving-device-identifier-or-address field;
a highest-completed-sequence-number field;
a highest-transmitted-sequence-number field; and
a bit map.

13. The method of claim of claim 13 wherein:
the values stored in the sequence-identifier field and receiving-device-identifier-or-address field together uniquely identify the sequence among all sequences in which the sending device participates;
the highest-completed-sequence-number field stores a value that identifies the sequence number of the data packet that constitutes the final data packet of an ordered subset of data packets transmitted through the sequence and acknowledged by the receiving device that includes the first transmitted data packet of the current data-transfer operation;
the highest-transmitted-sequence-number field stores a value that indicates the largest sequence number associated with a data packet transmitted to the receiving device by the sending device during the current data-transfer operation; and
the bit map indicates, for each data packet with a sequence number greater than the value stored in the highest-completed-sequence-number field and less than or equal to the value stored in the highest-transmitted-sequence-number field, whether or not the data packet has been acknowledged.

14. The method of claim 11 wherein the receiving-device sequence descriptor includes:
a sequence-identifier field;
a sending-device-identifier-or-address field;
a highest-completed-sequence-number field;
a final-sequence-number field; and
a bit map.

15. The method of claim of claim 14 wherein:
the values stored in the sequence-identifier field and sending-device-identifier-or-address field together uniquely identify the sequence among all sequences in which the receiving device participates;
the highest-completed-sequence-number field stores a value that identifies the sequence number of the data packet that constitutes the final data packet of an ordered subset of data packets received through the sequence and acknowledged by the receiving device that includes the first transmitted data packet of the current data-transfer operation;
the final-sequence-number field stores a value that indicates the largest sequence number associated with a data packet in the current data-transfer operation; and
the bit map indicates, for each data packet with a sequence number greater than the value stored in the highest-completed-sequence-number field and less than or equal to the value stored in the final-sequence-number field, whether or not the data packet has been received and acknowledged.

16. A sending device within a networking system comprising:
physical hardware, including a processor, an electronic memory, and a communications controller;
an operating system that controls the physical hardware, includes drivers, and provides a program-execution environment;
an application program that executes within the program-execution environment;
and a networking protocol implemented to transmit data in an ordered set of data packets through a sequence established between the sending device and a remote receiving device as a result of transmitting a first data packet from the sending device to the remote receiving device and receiving an acknowledgement from the remote receiving device by the sending device.

17. The sending device of claim 16 wherein the networking protocol is implemented in executable routines, firmware, hardware, or a combination of two or more of executable routines, firmware, hardware.

18. The sending device of claim 16 wherein a sequence comprises, with respect to the sending device, a sending-device sequence descriptor stored in a sequence-descriptor cache in a memory of the sending device.

19. The sending device of claim 18 wherein the sending-device sequence descriptor includes:
a sequence-identifier field;
a receiving-device-identifier-or-address field;
a highest-completed-sequence-number field;
a highest-transmitted-sequence-number field; and
a bit map.

20. The sending device of claim of claim 19 wherein:
the values stored in the sequence-identifier field and receiving-device-identifier-or-address field together uniquely identify the sequence among all sequences in which the sending device participates;
the highest-completed-sequence-number field stores a value that identifies the sequence number of the data packet that constitutes the final data packet of an ordered subset of data packets transmitted through the sequence and acknowledged by the remote receiving device that includes the first transmitted data packet of the current data-transfer operation;
the highest-transmitted-sequence-number field stores a value that indicates the largest sequence number associated with a data packet transmitted to the receiving device by the sending device during the current data-transfer operation; and
the bit map indicates, for each data packet with a sequence number greater than the value stored in the highest-completed-sequence-number field and less than or equal to the value stored in the highest-transmitted-sequence-number field, whether or not the data packet has been acknowledged.
